(19) United States
(12) Patent Application Publication
(10) Pub. No.: US 2006/0263068 A1
(43) Pub. Date: Nov. 23, 2006

(54) Reproducing apparatus, program, and reproduction control method

(75) Inventor: Yongjin Jung, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SONY CORPORATION

(21) Appl. No.: 11/435,828

(22) Filed: May 18, 2006

(30) Foreign Application Priority Data
May 19, 2005 (JP) P2005-147207

(51) Int. Cl. H04N 7/26

(52) U.S. Cl. 386/112

(57) ABSTRACT

The present invention provides a search apparatus that allows a user to execute search processing with ease without user's operating an operator block and checking information shown on a display block. The search apparatus has a name storage block, a vowel conversion block for converting name data stored in the name storage block into first vowel name data, a detection block for detecting an external impact applied by the user to the search apparatus or a myoelectric potential change caused by user movement as a user input signal, an analysis block for analyzing the user input signal to identify an input pattern, a vowel generation block for generating second vowel name data corresponding to the identified input pattern, an extraction block for making a comparison between the first vowel name data and the second vowel name data to extract one or more pieces of first vowel name data that match or are similar to the second vowel name data, and a list creation block for listing the name data corresponding to the extracted first vowel name data to create a candidate list.

### CROSS REFERENCES TO RELATED APPLICATIONS

The present invention contains subject matter related to Japanese Patent Application JP 2005-147207 filed in the Japanese Patent Office on May 19, 2005, the entire contents of which being incorporated herein by reference.

### BACKGROUND OF THE INVENTION

The present invention relates to a reproducing apparatus, a computer program, and a reproduction control method for reproducing content data.

Recently, portable reproducing devices (or portable players) capable of reproducing digital content data such as music content data (hereafter referred to simply as “content”) have been gaining popularity. Although, small in size for portability, these reproducing devices are capable of storing large amounts of content, supported by the increasingly expanding storage capacity of recording media.

These portable reproducing devices have each an operator section made up of buttons and a touch panel on the main body or a remote controller. Generally, the user operates this operator section to give commands to the reproducing device to execute various processing operations. For example, the user presses a skip button arranged on the main body of the reproducing device to switch between content data (for example, execute a music content track jump), thereby listening to desired content.

Further, the above-mentioned reproducing devices generally use a reproduction method in which, in reproducing plural pieces of stored content, the pieces of content to be reproduced are automatically selected for sequential and continuous reproduction in accordance with a sequence in which these pieces of content were stored or in accordance with a preset play list. At this moment, if there are stored large amounts of content as described above, the frequency increases in which pieces of content not to user's preference are selected for reproduction. Therefore, in order to listen to desired pieces of content, the must frequently issue commands for content reproduction switching during content reproduction.

### SUMMARY OF THE INVENTION

However, in the above-mentioned related-art reproducing devices, the user cannot give commands for content reproduction switching unless the user operates the above-mentioned operator section based on buttons and so on, thereby making the operation complicated. Especially, in an environment in which user's bodily movement is significantly restricted as in a significantly crowded train for example, it is very difficult for the user to take the main body or remote controller of the reproducing device out of the bag or a pocket of the suite for example, check the position of the buttons of the operator section, and execute necessary operations on the operator section.

On example in which music cueing is executed not by operating the operator section but by “shaking” the controller of an MD player horizontally is disclosed in Japanese Patent Laid-Open No. 2000-148351. However, in order to execute such a shaking operation, the user must take the main body of the reproducing device or the remote controller thereof out of the bag or a pocket of the suite for example, which is very difficult to do in an environment such as a crowed train. In addition, it is significantly cumbersome for the user to execute a content reproduction switching operation that is executed frequently during content reproduction as described above by “shaking” the reproducing device every time it is taken out.

Therefore, the present invention addresses the above-identified and other problems associated with related-art methods and apparatuses and solves the addressed problems by providing a novel and improved reproducing apparatus, computer program, and reproduction control method for easily realizing a content reproduction switching operation that is executed highly frequently during content reproduction without requiring the operation on the operator section of the reproducing apparatus even in an environment such as in a crowded train that hardly allows the free movement of the user's body for the operation of the reproducing apparatus.

In order to solve the above-mentioned problems, the inventor hereof has conceptualized an apparatus, a method, and a program for realizing the content reproduction switching that is executed most frequently in content reproduction by a reproduction apparatus without requiring the general operation of an operator block of the reproduction apparatus.

In carrying out the invention and according to one aspect thereof, there is provided a reproduction apparatus. This reproduction apparatus has a reproduction block for reproducing plural pieces of content stored in a storage medium; a detection block for detecting, as a user input signal, an external compact applied by a user to the reproduction apparatus during reproduction of content data by the reproduction block; an analysis block for analyzing the user input signal to identify an input pattern; a pattern storage block for storing a preset operation pattern; a command generation block for comparing the input pattern identified by the analysis block with the operation pattern stored in the pattern storage block to generate a command corresponding to an operation pattern that matches the input pattern; and a reproduction control block for switching content data to be reproduced by the reproduction block in accordance with the command.

In the above-mentioned reproduction apparatus, the plural pieces of content data stored in the storage medium are music content data and the reproduction control block switches content data to be reproduced by the reproduction block on one of a music content data title basis, a music content data album basis, and a music content data artist basis in accordance with a type of the command.

In the above-mentioned reproduction apparatus, the plural pieces of content data stored in the storage medium are classified into plural major categories and plural minor categories in accordance with the attribute information of contents data and the reproduction control block, when the command is entered during reproduction of content data in one minor category in one major category, switches to one of another piece of content data in a same minor category, a piece of content data in another minor category in a same major category, and a piece of content data in another major category in accordance with a type of the command.

In the above-mentioned reproduction apparatus, the plural pieces of content data stored in the storage medium are music content data and each of the plural major categories corresponds to an artist of the music content data and each of the plural minor categories corresponds to an album of the music content data.

The above-mentioned reproduction apparatus further has a control block for controlling at least one of capabilities of the reproducing apparatus such as power on/off, audio output volume up/down, content data search mode execution, content data repeat reproduction, content data reproduction start/stop, content data reproduction pause, and content data fast/rewind reproduction in accordance with a type of the command.

In the above-mentioned reproduction apparatus, the external impact to the reproduction apparatus is given by a vibration that is caused by tapping by a user's finger onto a housing of the reproduction apparatus.

In the above-mentioned reproduction apparatus, the detection block is an acceleration sensor for detecting a vibration caused by an external impact to the reproduction apparatus.

In the above-mentioned reproduction apparatus, the detection block is arranged around an inner surface of a housing of the reproduction apparatus.

In the above-mentioned reproduction apparatus, the detection block is a microphone for picking up an impact sound caused by the external impact to the reproducing apparatus.

In the above-mentioned reproduction apparatus, the detection block is arranged in the plural in the reproduction apparatus, thereby detecting both a position and a force of the external impact to the reproduction apparatus.

In the above-mentioned reproduction apparatus, a housing of the reproduction apparatus has at least one impact acceptance block for accepting the external impact applied by the user and the detection block is arranged in accordance with a position of the impact acceptance block.

In the above-mentioned reproduction apparatus, a housing of the reproduction apparatus has at least two impact acceptance blocks for accepting the external impact applied by the user and the analysis block analyzes the user input signal on the basis of a force of the external impact.

In the above-mentioned reproduction apparatus, the detection block is an acceleration sensor for detecting a vibration caused by the external impact to the reproduction apparatus and the acceleration sensor is arranged so as to detect a vibration in a direction in accordance with a direction of the external impact applied by the user to the impact acceptance block.

In the above-mentioned reproduction apparatus, the detection block and the impact acceptance block are each arranged in the plural and, in order to prevent a line connecting the plurality of detection blocks from orthogonally crossing a line connecting the plurality of impact acceptance blocks on a plane approximately vertical to a direction of the external impact to the reproduction apparatus, a relative position of the plurality of detection blocks and the plurality of impact acceptance blocks is adjusted.

In the above-mentioned reproduction apparatus, the analysis block analyzes the user input signal on the basis of a force of the external impact to the reproduction apparatus.

In the above-mentioned reproduction apparatus, the analysis block analyzes the user input signal on the basis of a time interval of the external impact to the reproduction apparatus.

In the above-mentioned reproduction apparatus, the analysis block analyzes the user input signal on the basis of a position of the external impact to the reproduction apparatus.

In the above-mentioned reproduction apparatus, the analysis block analyzes the user input signal on the basis of a count of the external impact to the reproduction apparatus.

In the above-mentioned reproduction apparatus, when the reproduction apparatus is powered on, the reproduction block automatically sequentially continuously reproduces the plural pieces of content data stored in the storage medium.

In the above-mentioned reproduction apparatus, the reproduction apparatus is a portable device.

The above-mentioned reproduction apparatus still further has a notification block for notifying the user of at least one of the input pattern identified by the analysis block and contents of the command generated by the command generation block.

In the above-mentioned reproduction apparatus, the content data includes at least one of audio data and video data.

In the above-mentioned reproduction apparatus, the reproduction control block notifies the user of necessary information in at least one of manners, audible and visual.

In carrying out the invention and according to another aspect thereof, there is provided a computer program for making a computer execute the steps of detecting, as a user input signal, an external impact applied by a user to the reproduction apparatus during reproduction of content data stored in a recording medium; analyzing the user input signal to identify an input pattern; comparing the identified input pattern with the operation pattern stored in the pattern storage block to generate a command corresponding to an operation pattern that matches the input pattern; and switching content data during reproduction in accordance with the command.

In carrying out the invention and according to still another aspect thereof, there is provided a computer-accessible storage medium storing the above-mentioned computer program.

In carrying out the invention and according to yet another aspect thereof, there is provided a reproduction control method including the steps of: detecting, as a user input signal, an external impact applied by a user to the reproduction apparatus during reproduction of content data stored in a recording medium; analyzing the user input signal to identify an input pattern; comparing the identified input pattern with the operation pattern stored in the pattern storage block to generate a command corresponding to an operation pattern that matches the input pattern; and switching content data during reproduction in accordance with the command.

As described above and according to the invention, a user is able to switch content to be reproduced to desired content by executing a simple operation such as tapping the reproduction apparatus with his finger, for example. Therefore, even if the user is in a physically tight environment such as inside a crowded train, the user is able to easily and quickly execute a content reproduction switching operation that is frequently executed in content reproduction, without operating the operator block of the reproduction apparatus.

### BRIEF DESCRIPTION OF THE DRAWINGS

Other objects and aspects of the invention will become apparent from the following description of embodiments with reference to the accompanying drawings in which:

FIG. 1 is block diagram illustrating an exemplary hardware configuration of a portable audio play, one of a reproducing apparatus practiced as one embodiment of the invention;

FIG. 2 is a block diagram illustrating an exemplary functional block of the reproducing apparatus associated with the above-mentioned embodiment;

FIG. 3 is a block diagram illustrating an exemplary configuration of a reproduction block associated with the above-mentioned embodiment;

FIG. 4 is a perspective view illustrating the installation of one acceleration sensor on the reproducing apparatus associated with the above-mentioned embodiment;

FIG. 5 is a schematic diagram illustrating a technique of analyzing a user input operation on the basis of a difference between vibration time intervals detected by an acceleration sensor associated with the above-mentioned embodiment;

FIG. 6 is a schematic diagram illustrating a technique of analyzing a user input operation on the basis of a difference between vibration forces detected by an acceleration sensor associated with the above-mentioned embodiment;

FIG. 7 is a perspective view illustrating the installation of two acceleration sensors on the reproducing apparatus associated with the above-mentioned embodiment;

FIG. 8 is a two-dimensional diagram illustrating an exemplary arrangement of the two acceleration sensors of the reproducing apparatus associated with the above-mentioned embodiment;

FIGS. 9A and 9B are perspective views illustrating a specific example of acceleration sensor and impact reception block arrangement in the reproducing apparatus associated with the above-mentioned embodiment;

FIGS. 10A and 10B are perspective views illustrating another specific example of acceleration sensor and impact reception block arrangement in the reproducing apparatus associated with the above-mentioned embodiment;

FIG. 11 is a perspective view illustrating an example in which a myoelectric potential sensor of the reproducing apparatus associated with the above-mentioned embodiment is attached to the wrist of the user;

FIG. 12 is a table indicative of a relationship between operation patterns stored in a pattern storage block of the reproducing apparatus associated with the above-mentioned embodiment and reproduction switching commands;

FIG. 13 is a table indicative of a relationship between operation patterns stored in the pattern storage block of the reproducing apparatus associated with the above-mentioned embodiment and search and special commands;

FIG. 14 is a diagram illustrating an exemplary play list of the reproducing apparatus associated with the above-mentioned embodiment;

FIG. 15 is a diagram illustrating a correlation between characters for use in a search mode associated with the above-mentioned embodiment and vowels and numbers;

FIG. 16 is a diagram illustrating a technique of converting name data into vowel data in the search mode associated with the above-mentioned embodiment;

FIG. 17 is a block diagram illustrating an exemplary functional configuration of a search block of the reproducing apparatus associated with the above-mentioned embodiment;

FIG. 18 is a flowchart indicative of a basic processing flow in the reproducing apparatus associated with the above-mentioned embodiment;

FIG. 19 is a flowchart indicative of an outline of a processing flow corresponding to each command type in the reproducing apparatus associated with the above-mentioned embodiment;

FIG. 20 is a flowchart indicative of a reproduction switching processing flow (or a reproduction control method) in the reproducing apparatus associated with the above-mentioned embodiment;

FIG. 21 is a flowchart indicative of a processing flow in the search mode (or a search method) in the reproducing apparatus associated with the above-mentioned embodiment;

FIG. 22 is a flowchart indicative of a processing flow in the search mode (or a search method) in the reproducing apparatus associated with the above-mentioned embodiment; and

FIG. 23 is a flowchart indicative of a special processing flow in the reproducing apparatus associated with the above-mentioned embodiment.

### DETAILED DESCRIPTION OF THE PREFERRED EMBODIMENTS

This invention will be described in further detail by way of embodiments thereof with reference to the accompanying drawings. It should be noted that components having the substantially the same functional configurations are dented by the same reference numerals to prevent the description thereof from overlapping.

### Embodiments

The following describes an example in which a search apparatus according to the invention is applied to a reproducing apparatus for reproducing content. A reproducing apparatus practiced as one embodiment of the invention is configured as a portable reproducing apparatus having a special sensor for detecting user input operations. This sensor is an acceleration sensor or a microphone for detecting a vibration or an impact sound generated by an external impact applied by user to the housing of the reproducing apparatus or a myoelectric potential sensor for detecting a change in myoelectric potential involved in a user movement. The reproducing apparatus configured as such handles an external impact or a myoelectric potential change detected by the above-mentioned sensor during the reproduction of content as a user input signal for instructing the reproducing apparatus to execute corresponding processing operations. Then, the reproducing apparatus compares the input pattern obtained by the analysis of this user input signal with a preset operation pattern to generate a command, thereby executing a user-specified processing operation. The following details the configuration of this reproducing apparatus and operations to be executed thereby.

It should be noted that, in what follows, descriptions will be made by use of, but not exclusively, examples of content data, such as audio content, especially music content distributed from distribution servers, content stored in removable recording media including music CD (Compact Disc), and music content ripped from music CDs and stored in recording media including HDD, semiconductor memory device, and MD (Mini Disc). Also, in what follows, descriptions will be made by use of, but not exclusively, a portable audio player for reproducing the above-mentioned content as an example of the reproducing apparatus.

1. Configuration of the Reproducing Apparatus:

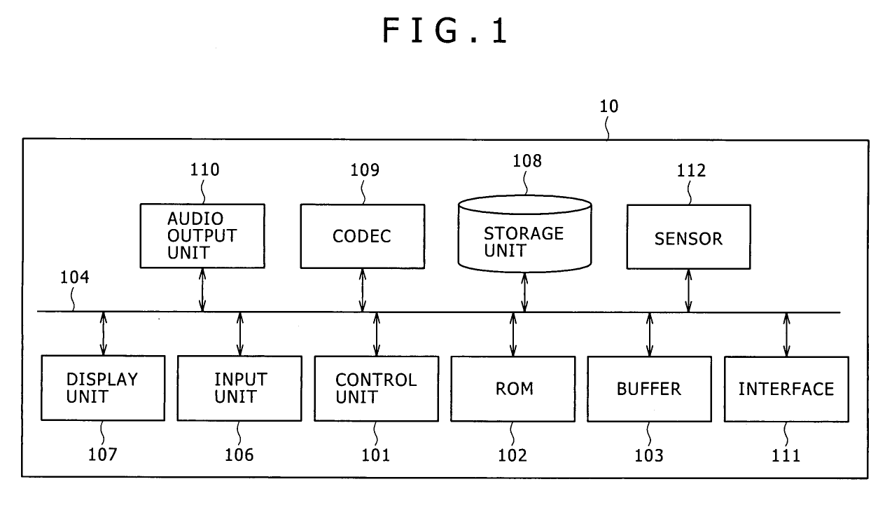

First, a hardware configuration of a reproducing apparatus 10 practiced as one embodiment of the invention will be described with reference to FIG. 1. FIG. 1 is a block diagram illustrating a hardware configuration of a portable audio player, one example of the reproducing apparatus 10.

As shown in FIG. 1, the reproducing apparatus 10 has a control unit 101, a ROM 102, a buffer 103, a bus 104, an input unit 106, a display unit 107, a storage unit 108, a CODEC (Compression/Decompression) 109, an audio output unit 110, an interface 111, and the above-mentioned special sensor 112.

The control unit 101, made up of a CPU or a microcontroller, for example, controls the other components of the reproducing apparatus 10. The ROM 102 stores programs for controlling the operation of the control unit 101 and various kinds of data including the attribute information associated with content and list information. The buffer 103, made up of an SDRAM (Synchronous DRAM) for example, temporarily stores various kinds of data associated with the processing by the control unit 101.

The bus 104 is a data line for interconnecting the control unit 101, the ROM 102, the buffer 103, the input unit 106, the display unit 107, the storage unit 108, the CODEC 109, the audio output unit 110, the interface 111, and the sensor 112.

The input unit 106 is equivalent to an operator block generally arranged on the reproducing apparatus 10, accepting user input operations. The input unit 106 is made up of controls including operation button, touch panel, button key, lever, and dial and an input control circuit for generating user input signals corresponding to user operations done on the control unit 101 and outputting the generated user input signals to the control unit 101, for example. The input unit 106 also has a remote controller (not shown) connected to the main body of the reproducing apparatus 10, in addition to the operator block arranged on the main body of the reproducing apparatus 10. Operating the input unit 106, the user of the reproducing apparatus 10 is able to give instructions to the reproducing apparatus 10 for executing processing operations, enter various kinds of data into the reproducing apparatus 10, and generate content play lists, for example. It should be noted that some of the input capabilities of the input unit 106 may be taken over by the a detection block 12 to be described later, details of which will be described later.

The display unit 107 is made up of display devices such as a liquid crystal display (LCD) panel and an LCD control circuit for example. The display unit 107 includes a main display panel and a sub display panel that is arranged on a remote controller. Under the control of the reproducing apparatus 10, the display unit 107 displays various kinds of information such as a content play list, a candidate list indicative of search results, attribute information of content being reproduced (music title, album name, artist name, reproduction time, for example), and an operation of the reproducing apparatus 10 (reproduction, search mode, rewind, and fast feed, for example) in the form of text or image. It should be noted that the display unit 107 need not always be arranged.

The storage unit 108 is used to store various kinds of data such as content into recording media. For example, the storage unit 108 is a hard disc drive (HDD). The storage unit 108 has a storage medium such as a HDD or a semiconductor memory (or a flash memory), for example. The storage unit 108 thus configured stores plural pieces of content, programs of the control unit 101, processing data, and other various kinds of data. The storage unit 108 is equivalent to examples of a content storage unit and a name storage unit.

It should be noted that the reproducing apparatus 10 may have a drive (not shown) for reading/writing various data including content with removal storage media such as optical discs including CD, MD, DVD, magnetic discs, or semiconductor memories, for example. The drive allows the reproducing apparatus 10 to read content from a removable storage medium loaded on the drive to reproduce the read content. Namely, the above-mentioned storage medium storing content may be this removal storage medium.

The CODEC 109 is an electronic circuit for compressing (or encoding) and decompressing (or decoding) content and is made up of a decoder and an encoder to be described later. It should be noted that the CODEC 109 may be configured by software rather than hardware.

The audio output unit 110 outputs reproduced content (music content for example) in an audible manner. The audio output unit 110 amplifies analog audio content data decoded and D/A-converted by reproduction processing and outputs the amplified data to an earphone or headphone (not shown) for example, sounding the audio data through a speaker (not shown) incorporated therein. Consequently, the user is able to listen, by means of an earphone for example, the music content reproduced by the reproducing apparatus 10.

The interface 111 is a communication block for communicatively connecting the reproducing apparatus 10 to external equipment such as an information processing apparatus (a personal computer for example). The interface 111 is made up of a communication controller such as a USB (Universal Serial Bus) controller for example and a connector terminal such as a USB terminal or a wireless communication circuit. The interface 111 allows the reproducing apparatus 10 to transfer content and various kinds of data including content attribute information and control signals with a wiredly or wirelessly connected information processing apparatus and a myoelectric potential sensor, for example.

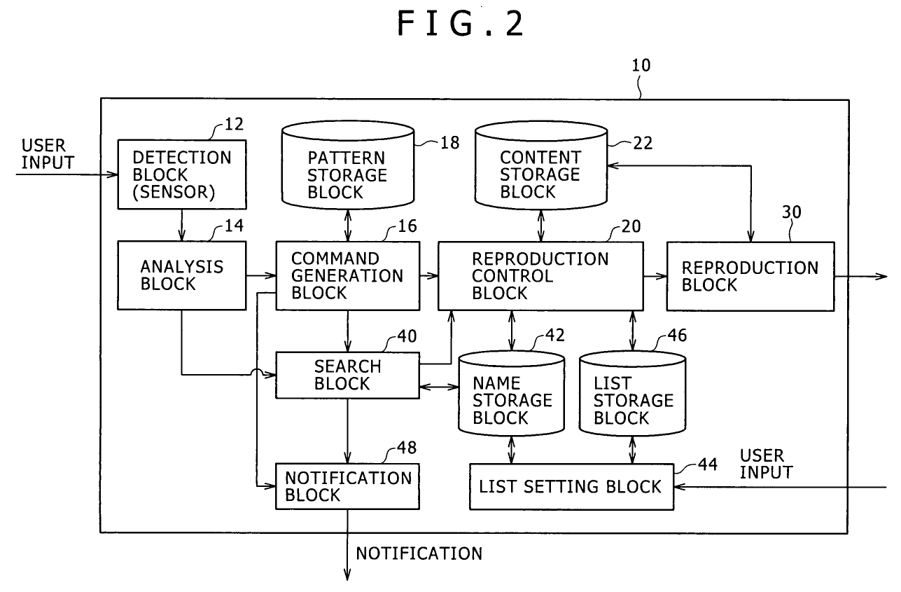

The following describes a functional configuration of the reproducing apparatus 10 according to the present embodiment with reference to FIG. 2. FIG. 2 is a block diagram illustrating a functional configuration of the reproducing apparatus 10.

As shown in FIG. 2, the reproducing apparatus 10 has a detection block 12 for detecting an external impact applied to the reproducing apparatus 10 or a myoelectric potential change caused by a user movement as a user input signal, an analysis block 14 for analyzing the user input signal to identify an input pattern, a pattern storage block 18 for storing a plurality of preset operation patterns, a command generation block 16 for comparing the above-mentioned input pattern with the above-mentioned operation pattern to generate commands, a reproduction control block 20 for controlling the reproduction of content in accordance with the generated commands, a content storage block 22 for storing plural pieces of content, a reproduction block 30 for reproducing content, a search block 40 for executing content search processing, a name storage block 42 for storing name data associated with plural pieces of content, a list setting block 44 for setting play lists, a list storage block 46 for storing one or more set lists, and a notification block 48 for notifying the user of the above-mentioned commands for example.

The detection block 12 is a sensor (equivalent to the sensor 112 shown in FIG. 1) for detecting an external impact applied to the housing of the reproducing apparatus 10 by the user and a myoelectric potential change caused by a user movement. To be more specific, the detection block 12 is made up of an acceleration sensor for detecting a vibration generated by the above-mentioned external impact, a microphone for detecting an impact sound caused by the above-mentioned external impact, or a myoelectric potential sensor for detecting a myoelectric potential change involved in a user movement. The detection block 12 thus configured detects a vibration or a impact sound caused by user's applying an external impact to the housing of the reproducing apparatus 10 by tapping the housing by the finger for example or a myoelectric potential change caused when the user moves the finger for example and outputs a result of this detection to the analysis block 14 as a user input signal for instructing the reproducing apparatus 10 to execute a particular processing operation.

The analysis block 14 analyzes the user input signal supplied from the detection block 12, namely, a vibration or an impact sound caused by an external impact applied to the reproducing apparatus 10 or a myoelectric potential change. The analysis block 14 executes the analysis processing on the basis of the force, time interval, position, and count for example of the above-mentioned external impact or myoelectric potential change, details of which will be described later. Then, on the basis of a result of this analysis, the analysis block 14 identifies an input pattern intended by the user and outputs the identified input pattern to the command generation block 16. This input pattern is indicative of the force, position, or count or a combination thereof of the above-mentioned external impact or myoelectric potential change. The input pattern depends on a manner in which the user makes input operations, namely, an external impact is applied to the reproducing apparatus 10, and a user operation (or a finger movement) for causing a myoelectric potential change.

The command generation block 16 compares the input pattern identified by the analysis block 14 with a plurality of operation patterns stored in the pattern storage block 18 to identify an operation pattern that matches the above-mentioned input pattern. This input pattern is indicative of the force, position, or count or a combination thereof of the above-mentioned external impact or myoelectric potential change. This operation pattern is preset for each procession operation of the reproducing apparatus 10. For example, an operation in which a predetermined position of the reproducing apparatus 10 is lightly tapped twice (or the index finger is moved twice) when an acceleration sensor is used as the detection block 12 and an operation pattern in which the index finger is moves twice when a myoelectric potential sensor is used are set so as to correspond to a processing operation that the reproduction of music content is switched on a piece of music basis (namely, a track jump is executed). An operation pattern in which different positions of the reproducing apparatus 10 are each tapped on once alternately when an acceleration sensor is used as the detection block 12 and an operation pattern in which the index finger and the middle finger are each moved once alternately when a myoelectric potential sensor is used are set so as to correspond to a processing operation that the reproduction of music content is switched on an album basis.

Further, the command generation block 16 generates a command specifying a processing operation corresponding to the operation pattern that matches the input pattern and outputs the generated command to the reproduction control block 20 or the search block 40. This command is a signal for specifying a processing operation (reproduction switching operation, search processing operation, or power on/off operation, for example) of the reproducing apparatus 10. For example, the command generation block 16 outputs a content reproduction switching command to the reproduction control block 20 for switching content reproduction. In addition, the command generation block 16 outputs a search command to the search block 40 for executing the search mode of, content.

The reproduction control block 20 controls the reproduction of plural pieces of content stored in the content storage block 22. For example, when the reproducing apparatus 10 is powered on, the reproduction control block 20 controls the reproduction block 30 so as to automatically sequentially reproduce plural pieces of content stored in the content storage block 22 in accordance with a preset play list or a candidate list to be described later. This saves the user to execute cumbersome input operations such as individually selecting the content to be reproduced. However, the present invention is not restricted to this configuration; for example, the reproduction control block 20 is also capable of executing control so as to reproduce one or more user-selected pieces of content or the content stored in a user-selected album.

Also, the reproduction control block 20 controls the reproduction of content by the reproduction block 30 in accordance with commands entered through the above-mentioned command generation block 16. For example, in accordance with an entered reproduction switching command, the reproduction control block 20 is able to switch the music content to be reproduced by the reproduction block 30 on a title basis, on an album basis, or on an artist basis. It should be noted that a music content album is a collection of plural pieces of music content and is equivalent to a collection of music stored in each music CD on the market, for example. The artist of music content refers to the singer, performer, composer, adapter, or producer of that music content, for example.

In addition, in accordance with the types of entered commands, the reproduction control block 20 is capable of controlling various reproduction operations (reproduction start/stop, reproduction pause, fast feed reproduction, rewind reproduction, and repeat reproduction, for example) by the reproduction block 30 and various operations (power on/off and audio volume control, for example) of the reproducing apparatus 10.

On the basis of the above-mentioned reproduction control by reproduction control block 20, the reproduction block 30 reproduces the content stored in the content storage block 22, sounding the reproduced content through the audio output unit 110.

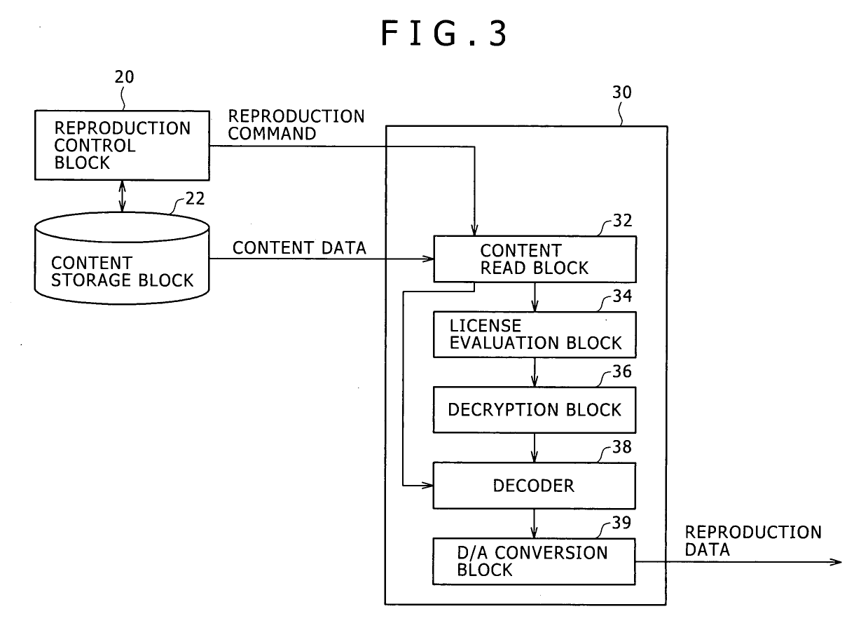

The following describes an exemplary configuration of the reproduction block 30 with reference to FIG. 3. FIG. 3 is a block diagram illustrating an exemplary configuration of the reproduction block 30.

As shown in FIG. 3, the reproduction block 30 has a content read block 32 for reading content from the content storage block 22 in accordance with a reproduction command given from the reproduction control block 20, a license evaluation block 34 for evaluating a license accompanying content, a decryption block 36 for decrypting encrypted content, a decoder 38 for decoding compressed content, and a D/A conversion block 39 for converting digital content into analog content.

To be more specific, the content read block 32 sequentially reads the pieces of content specified by the reproduction control block 20 for reproduction. Further, the content read block 32 is capable of reading content attribute information (title, artist name, reproduction time, and other meta information of content) associated with the content subject to reproduction from the content storage block 22 or the name storage block 42. The content attribute information may be associated with content and stored separate therefrom or together therewith. The content attribute information thus read may be displayed on the display unit 107 as required.

The license evaluation block 34 evaluates the license of each piece of content read as above to determine whether the read piece of content can be reproduced or not. To be more specific, if the content whose copyright is managed by the DRM (Digital Rights Management) technology is subject to reproduction, that content cannot be reproduced unless the reproduction conditions (the number of times the content concerned can be reproduced or a reproduction count, the expiration date until which the content concerned can be reproduced, and so on) written in the license of the content concerned are satisfied. Therefore, the license evaluation block 34 first gets the license and key information associated with the content subject to reproduction, decrypts the license with this key information, and evaluates the validity of the license. If the license is found valid by the license evaluation block 34, the license evaluation block 34 evaluates the reproduction conditions in the license to determine whether the content can be reproduced, and outputs the determination to the decryption block 36.

If the license evaluation block 34 determines the content can be reproduced, then the decryption block 36 decrypts the encrypted content by use of the key information and outputs the decrypted content to the decoder 38. It should be noted that, if content not managed in copyright is to be reproduced (for example, to reproduce content read from a music CD), the above-mentioned license evaluation processing by the license evaluation block 34 and the above-mentioned decryption processing by the decryption block 36 may be skipped. In this case, the content read by the content read block 32 is directly entered in the decoder 38.

The decoder 38 executes decode processing, surround processing, and PCM data conversion processing on the content read by the content read block 32 or the copyright-managed content decrypted by the decryption block 36 and outputs the decoded content to the D/A conversion block 39. It should be noted that the decoder 38, which is hardware making up a part of the above-mentioned CODEC 109, may be configured by software having the above-mentioned decryption capability.

The D/A conversion block 39 converts the digital content data (PCM data for example) entered from the above-mentioned decoder 38 into analog content data (or reproduction data) and outputs the converted content data to the audio output unit 110, sounding the content therefrom.

The reproduction block 30 thus configured is able to execute the processing of reproducing content, namely, decrypting the digital content compliant with a predetermined compression standard stored in the content storage block 22 and converting the decrypted content into a data format in which the content can be sounded from the audio output unit 110.

Referring to FIG. 2 again, the search block 40 executes a content search mode operation when a search mode execution command is entered from the command generation block 16. The search mode is a processing mode for searching for the name associated with a piece of music content that the user wants to reproduce; namely, the title, album name, or artist name for example of that content. In the search mode, on the basis of a user input signal detected by the detection block 12, the search block 40 vowel-searches for the title, album name, or artist name for example of a piece of music that the user wants to reproduce, thereby creating a candidate list. Details of the search block 40 will be described later.

The name storage block 42 stores the name data indicative of the names associated with content. The name data includes the title, album name, and/or artist name, for example, of music content. The name data and each piece of content are related with each other by content identification information such as a content ID for example. Namely, in the above-mentioned content storage block 22, pieces of content and corresponding content IDs are stored as related with each other. Further, in the name storage block, the name data associated with pieces of content and the corresponding content IDs are stored as related with each other. Therefore, if the name data is identified, the piece of content corresponding to that name data is also identifiable. It should be noted that the name storage block 42 and the content storage block 22 may be configured by a same storage medium (the storage unit 108 for example) of the reproducing apparatus 10 or two different storage media (for example, the storage unit 108 and a removable storage medium).

The list setting block 44 sets a play list indicative of a sequence in which some or all of pieces of content stored in the content storage block 22 are reproduced. The list setting block 44 stores the play list into the list storage block 46. The list setting block 44 can newly create a play list indicative of plural pieces of content selected by the user and register the created play list with the list storage block 46 or register an existing play list acquired from an external device with the list storage block 46. It should be noted that the list setting block 44 is capable of setting a plurality of play lists and register them with the list storage block 46.

The above-mentioned play list setting capability of the list setting block 44 allows the user to intentionally select some pieces of content from among the pieces of content stored in the content storage block 22 and create a play list on the basis of the selected pieces of content. This play list may be various, such as a play list in which pieces of content of user preference are collected (for example, the best 10 of the music content of user preference among the pieces of content released in April 2005) or a play list in which the pieces of content having a same attribute are collected (for example, a best album of the music content of artist A selected according to user preference or a jazz list of the music content associated with jazz), for example. It should be noted that this play list may be created on an album basis or an artist basis, in addition to a content basis.

Also, each content providing business (or a so-called label or the like) is able to create the above-mentioned play list for users. For example, each content providing business can create a play list containing pieces of content high in popularity on the basis of recent hit charts for example or a play list containing pieces of content not well known in general but recommended by that business. This business-created play list may be obtained by the reproducing apparatus 10 by downloading the play list from a distribution server via a network by use of an information processing apparatus and transmitting the downloaded play list from the information processing apparatus to the reproducing apparatus 10 or by reading, by the reproducing apparatus 10, the play list from a removable recording medium provided by the business.

If a command comes for reproducing a particular play list, the reproduction control block 20 sequentially and continuously reproduces the pieces of content contained in that play list. Consequently, the user is able to continuously listen to the music content in the play list. When the reproducing apparatus 10 is powered on, the reproduction control block 20 controls such that the play list is sequentially and continuously reproduced starting with the position at which the last reproduction ended. It should be noted that, during a predetermined period after the creation of the above-mentioned play list, for example, the reproduction control block 20 controls so as to sequentially and continuously reproduces content according to a candidate list concerned instead of the above-mentioned play list, details of which will be described later.

The notification block 48 notifies the user of an input operation done by the user to the reproducing apparatus 10 and a processing operation executed by the reproducing apparatus 10 in accordance with the user input operation. For example, the notification block 48 notifies the user of a command generated by the command generation block 16 and various kinds of information such as a result of a search operation executed by the search block 40. In this notification processing, the notification block 48 may make notification in an audible manner by use of the audio output unit 110 or, if the reproducing apparatus 10 has the display unit 107, in a visible manner by use of the display unit 107.

For example, if a “title-basis reproduction switching command” is generated by the command generation block 16, then the notification block 48 audibly notifies the user of the execution of a reproduction switching operation on a title basis. This allows the user to make a confirmation whether an operation pattern entered by the user is valid or invalid and consequently whether an operation command desired by the user is executed correctly or not. If a “search command” is generated by the command generation block 16, then the notification block 48 audibly notifies the user of the execution of the search mode by the reproducing apparatus 10. This allows the user to recognize the start of the search mode and enter the name data subject to search. It should be noted that the above-mentioned notification processing by the notification block 48 may not always be executed.

The configuration of the reproducing apparatus 10 practiced as one embodiment of the invention is as described above. This configuration allows the user to easily and quickly instruct the reproducing apparatus 10 to execute desired processing operations, especially desired content reproduction switching operations, simply by tapping the housing of the reproducing apparatus 10 with the finger or moving the finger of the arm on which a myoelectric potential sensor is mounted, without operating the input unit 106 of the reproducing apparatus 10.

It should be noted that the detection block 12, the analysis block 14, the command generation block 16, the reproduction control block 20, the reproduction block 30, the search block 40, the list setting block 44, and the notification block 48 each may be configured as hardware or by software by installing a corresponding program in the control unit 101 of the reproducing apparatus 10. For example, the reproduction block 30 may be configured by a reproduction circuit having a content reproduction capability or a software program for content reproduction installed in the control unit 101. Of the components of the reproduction block 30 shown in FIG. 3, the decoder 38 and the D/A conversion block 39 for example may be configured by dedicated circuits and others by software.

The pattern storage block 18, the content storage block 22, the name storage block 42, and list storage block 46 shown in FIG. 2 are configured by a storage medium (the storage unit 108 shown in FIG. 1) in the reproducing apparatus 10 or a removable storage medium (for example, music CD, MD, DVD, or semiconductor memory) that is loaded on the reproducing apparatus 10, for example.

2. User Input Detection and Analysis Processing:

The following describes details of the processing of detecting and analyzing an external impact or a myoelectric potential change by the reproducing apparatus 10 and the input pattern identification processing by the reproducing apparatus 10 based on the detection and analysis processing.

As described above, the reproducing apparatus 10 practiced as one embodiment of the invention detects, through the detection block 12, an external impact caused by user's tapping the reproducing apparatus 10 or a myoelectric potential change caused by user's moving the finger, as a user input signal indicative of an operation command by the user. Further, the analysis block 14 analyzes the user input signal that is an external impact caused by user's tapping the reproducing apparatus 10 or a myoelectric potential change caused by user's moving the finger on the basis of the force, time interval, position, and count for example thereof, thereby identifying an input pattern. Further, user input signals as the external impact or myoelectric potential change are classified into patterns beforehand and these patterns are stored in the pattern storage block 18 as operation patterns corresponding to operation commands to the reproducing apparatus 10. This configuration allows the user to make a matching between these operation patterns and the above-mentioned identified input pattern to instruct the reproducing apparatus 10 to execute desired processing operations.

In what follows, an example will be described in which an acceleration sensor for detecting a vibration caused by an external impact applied to the reproducing apparatus 10 is arranged thereon to detect, analyze and pattern user input signals indicative of vibrations, thereby identifying user operation commands.

2.1 Detection and Analysis Processing Based on One Acceleration Sensor:

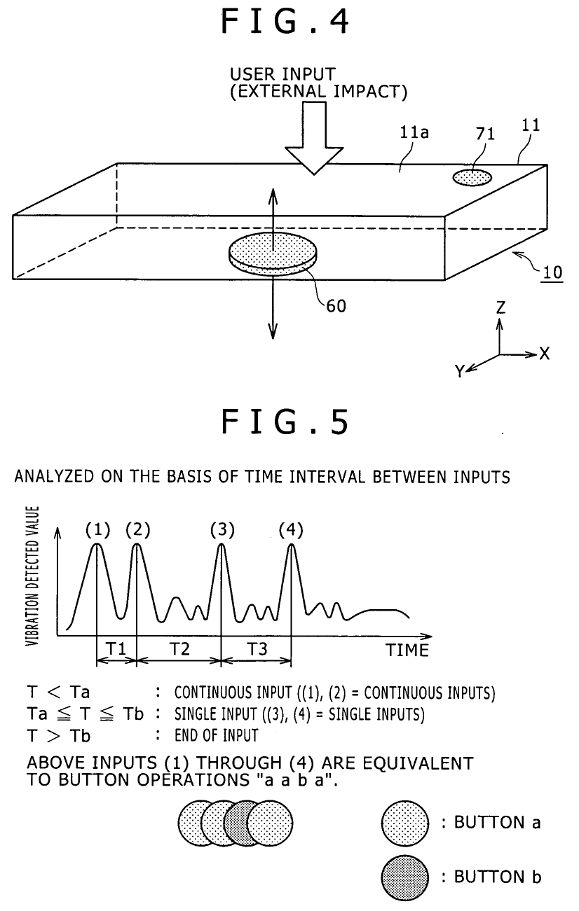

First, the processing of detecting and analyzing a vibration caused by an external impact by use of one acceleration sensor 60 will be described with reference to FIG. 4. FIG. 4 is a perspective view illustrating an example in which the acceleration sensor 60 is arranged on the reproducing apparatus 10 practiced as one embodiment of the invention.

As shown in FIG. 4, the reproducing apparatus 10 incorporates one acceleration sensor 60. This acceleration sensor 60 is arranged so as to detect a vibration in a direction of the application of an external impact by the user (namely Z-direction in FIG. 4).

To be more specific, a housing 11 of the reproducing apparatus 10 shown in FIG. 4 has an approximately cuboid that is flat in Z-direction, for example. In tapping the reproducing apparatus 10 thus configured, it would be easy for the user to tap on a side 11a that has a largest area among the six side faces of the housing 11, especially, a central portion of this side face 11a. Further, in tapping on the side face 11a, the user taps on the side face 11a in generally a perpendicular direction (Z-direction), so that a vibration is caused on the reproducing apparatus 10 mainly in Z-direction.

Consequently, the acceleration sensor 60 is arranged in the direction of XY plane in the example shown in FIG. 4 and in the rear of the central portion of the side face 11a at which it is easy for the user to tap on, namely, at the center of the housing 11. In addition, in order to surely detect the vibration in Z-direction, the acceleration sensor 60 is arranged around an inner surface of the main body such that the vibration detection direction of the sensor is perpendicular to the side face 11a. This arrangement of the acceleration sensor 60 allows the accurate detection of microscopic vibrations in Z-direction that are generated even when the user lightly taps on the central portion of the side face 11a of the housing 11 with the finger.

The following describes a technique for input pattern identification based on the analysis of vibrations detected by the acceleration sensor 60 in the case where only one acceleration sensor 60 is arranged as shown in FIG. 4. The technique includes one that vibration analysis is executed on the basis of the difference between time intervals or forces of vibrations detected by the acceleration sensor 60.

FIG. 5 illustrates a technique of analyzing user inputs on the basis of the difference between time intervals of vibrations detected by the acceleration sensor 60.

As shown in a vibration waveform diagram shown in FIG. 5, if the user taps the housing 11 of the reproducing apparatus 10 several times (4 times in the figure), 4 peaks (1) through (4) appear on the force of a vibration detected by the acceleration sensor 60, these peaks corresponding to the time intervals with which the user has tapped the housing 11.

The analysis block 14 measures time intervals T1 through T3 of between peaks (1) through (4) and analyzes the user input on the basis of a different between the obtained time intervals T1 through T3 of the vibration. To be more specific, the analysis block 14 holds preset predetermined continuous input time Ta and single input time Tb. If time interval T between two detected vibrations is smaller than continuous input time Ta, then the analysis block 14 determines that the these two detected vibrations are of a continuous input operation by the user, thereby determining that a same operation has been made two or more times. For example, time interval T1 between vibration peaks (1) and (2) is lower than continuous input time Ta, so that the analysis block 14 determines that this is a continuous input of same operations.

If time interval T between two detected vibrations is equal to or greater than continuous input time Ta and equal to or smaller than signal input time Tb, then the analysis block 14 determines that these two vibrations are two separate individual inputs, thereby determining that different operations have been entered each once. For example, because time interval T2 between vibration peaks (2) and (3) and time interval T3 between vibration peaks (3) and (4) are each equal to or greater than continuous input time Ta and equal to or smaller than single input time Tb, the analysis block 14 determines that different inputs have been entered. If a time longer than single input time Tb has passed, then the analysis block 14 determines that an input operation by the user has ended.

Thus, by analyzing the time intervals of detected vibrations, the analysis block 14 is able to identify an input pattern corresponding to a user input signal as a vibration (namely, an input operation effected by user's tapping the housing 11). The identified input pattern can be replaced by different types of operations (two types of button operations for example) that are made on the input unit 106 by the user. For example, if an input pattern is replaced by input operations of two buttons a and b, then a vibration detection signal having the waveform shown in FIG. 5 can be replaced by button operations “a a b a” (that is, button a is pressed by the user twice, button b once, and then button a once again).

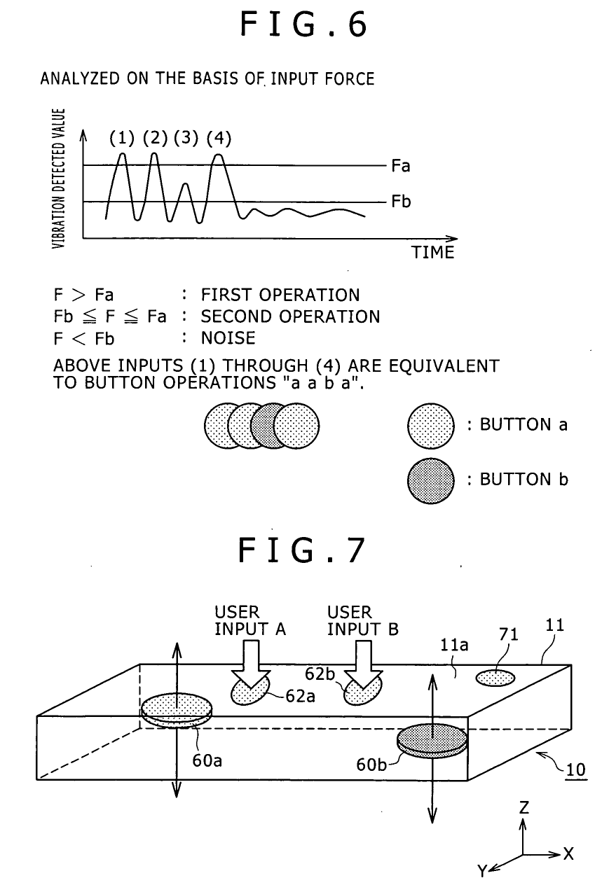

FIG. 6 shows a technique in which each user input operation is analyzed on the difference between forces of vibrations detected by the acceleration sensor 60.

As shown in the vibration wave diagram shown in FIG. 6, when the user taps on a same position of the housing 11 of the reproducing apparatus 10 with different forces or different positions relative to the acceleration sensor 60 with a same force, there occurs a difference between the forces of vibrations detected by the acceleration sensor 60. In the example shown in FIG. 6, large peaks (1), (2), and (4) and a small peak (3) occur in accordance with the forces of the tapping by the user.

The analysis block 14 measures the forces of these vibration peaks (1) through (4) and, on the basis of the obtained vibration forces, analyzes each user input. For example, the analysis block 14 makes a comparison between vibration peaks (1) through (4) greater than noise to classify vibration inputs into a plurality of types (two types for example). To be more specific, the analysis block 14 holds preset first vibration force Fa and second vibration force Fb. If force F of a detection vibration is greater than first vibration force Fa, then the analysis block 14 determines that first operation has been inputted. If force F is equal to or greater than second force Fb and equal to or smaller than first force Fa, then the analysis block 14 determines that the second operation has been inputted. If force F is smaller than second force Fb, then the analysis block 14 determines that the input is noise. Consequently, in the example shown in the vibration waveforms shown in FIG. 6, two types are obtained, namely, the vibration inputs having large peaks (1), (2), and (4) corresponding to the first operation and the vibration input having small peak (3) corresponding to the second operation.

As described, by analyzing the force of each detected vibration, the analysis block 14 can identify an input pattern corresponding to a user input signal (or an input operation in which the user taps the housing 11) as a vibration. This input pattern may be replaced by operations of different types (button operations of two types for example) to be executed on the input unit 106 by the user, as with the above. With an example in which the input operations of two buttons a and b for instance are replaced, the vibration detection signal having the waveform shown in FIG. 6 can be replaced by button operations “a a b a.”

As described above with reference to FIGS. 5 and 6, even the arrangement of only one acceleration sensor 60 allows the analysis block 14 to identify an input pattern on the basis of the difference between time intervals (namely, time intervals of detected vibrations) in which the user taps the housing 11 or tapping forces (namely, the forces of detected vibrations), thereby replacing the identified input pattern by input operations of two types for example. It should be noted that the techniques shown in FIGS. 5 and 6 may be used together to identify more complicated and various input patterns.

2.2 Detection and Analysis Processing Based on Two Acceleration Sensors:

The following describes the processing of detection and analysis of vibrations caused by external impacts applied by the user to the reproducing apparatus 10, by use of two acceleration sensors, with reference to FIG. 7. FIG. 7 is a perspective view illustrating an example in which two acceleration sensors 60a and 60b are arranged on the reproducing apparatus 10 practiced as one embodiment of the invention.

As shown in FIG. 7, the reproducing apparatus 10 incorporates two acceleration sensors 60a and 60b, or a first sensor and a second sensor (hereafter sometimes generically referred to as the acceleration sensor 60) inside the housing 11 having approximately cuboid that is flat in Z-direction as with shown in FIG. 4. Of the six side faces of the housing 11 of the reproducing apparatus 10, a side face 11a having a widest area carries two impact acceptance sections 62a and 62b for example (hereafter sometimes generically referred to as an impact acceptance section 62) that accepts external impacts applied by the user.

The impact acceptance sections 62a and 62b are arranged at positions that allow easy tapping on by the user with his index finger and middle finger for example, in the vicinity of the center of the side face 11a inside the housing 11 for example, in a spaced relation from each other, for example. The impact acceptance section 62 may be configured by any embosses on the housing 11, other members (seals, shock absorbers, or the like) attached to the housing 11, or mere labels attached on the housing 11, for example, as long as these allow the user to recognize tapping positions. The user lightly taps on the impact acceptance sections 62a and 62b with his index finger and middle finger to give impacts, thereby issuing a command for triggering the execution of desired processing operations of the reproducing apparatus 10.

In the reproducing apparatus 10 thus configured, the acceleration sensors 60a and 60b are arranged so as to detect the vibrations in a direction according to a direction (namely, Z-direction shown in FIG. 7) in which external impacts are applied to the impact acceptance sections 62a and 62b by the user. To be more specific, if the user taps on the impact acceptance section 62 as with the example shown in FIG. 4, the user taps in a direction generally perpendicular (or Z-direction) to the side face 11a on which the impact acceptance section 62 is arranged, so that a vibration in Z-direction occurs on the reproducing apparatus 10. Hence, each of the acceleration sensors 60a and 60b is arranged in a direction (or Z-direction) in which the vibration detecting direction is perpendicular to the side face 11a so as to correctly detect the vibration in Z-direction. The arrangement in this manner allows the correct detection of even a microscopic vibration caused in Z-direction by a light tapping by the user on the impact acceptance section 62 of the housing 11.

Further, the acceleration sensors 60a and 60b are arranged in the housing 11 of the reproducing apparatus 10 at positions as spaced from each other as possible so as to separately detect the vibrations caused by external impacts applied to the impact acceptance sections 62a and 62b, these positions corresponding to the positions of the impact acceptance sections 62a and 62b.

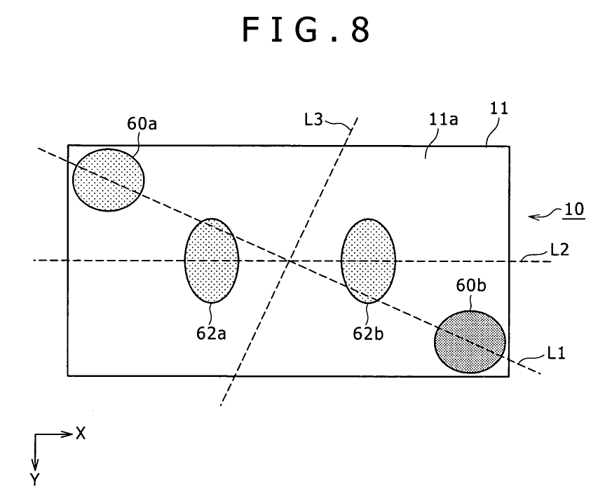

To be more specific, the two acceleration sensors 60a and 60b are arranged in the opposite corners in the housing 11 of the reproducing apparatus 10 as shown in FIG. 8, thereby being spaced from each other as far as possible. In addition, the relative positions of the acceleration sensors 60a and 60b and the impact acceptance sections 62a and 62b are adjusted so as to prevent line L1 connecting the acceleration sensors 60a and 60b and line L2 connecting the impact acceptance sections 62a and 62b from orthogonally crossing each other on a plane (XY plane) perpendicular to the direction (namely Z-direction) of an external impact. The following describes the reason why this adjustment is made.

As described above, the user taps on the impact acceptance sections 62a and 62b of the reproducing apparatus 10 with his index finger and middle finger for example, thereby executing an input operation. At this moment, the force of vibration (or a vibration detection value) detected by the acceleration sensors 60a and 60b depends on the distance between the impact acceptance sections 62a and 62b on which the tap has been made and the acceleration sensors 60a and 60b. The vibration detection value of each acceleration sensor 60 is a function of the distance between the impact acceptance section 62, which is the source of vibration, and the acceleration sensor 60, and a force with which the impact acceptance section 62 was tapped on. Hence, the reproducing apparatus 10 shown in FIG. 7 has a configuration in which a distinction is made between the impact to the impact acceptance section 62a and the impact to the impact acceptance section 62b by use of two acceleration sensors 60, thereby determining two types of input operations.

However, if the distance between the two acceleration sensors 60a and 60b is relatively short, there occurs not enough distance between each of the impact acceptance sections 62 and the acceleration sensor 60a and the acceleration sensor 60b, so that it becomes difficult to determine which of the impact acceptance sections 62a and 62b has been tapped on. To overcome this problem, present embodiment provides as a large space as possible between the acceleration sensor 60a and the acceleration sensor 60b in the housing 11 of the reproducing apparatus 10 as shown in FIG. 8. This arrangement makes large the difference between the vibration detection values in the acceleration sensors 60a and 60b, thereby suitably detecting which of the impact acceptance sections 62a and 62b has been tapped on.

If line L1 connecting the acceleration sensors 60a and 60b and line L2 connecting the impact acceptance sections 62a and 62b orthogonally cross each other on xy plane (namely, if the line L2 matches line L3 that orthogonally crosses line L1), the distance from the impact acceptance section 62a, which is the source of vibration, to each of the acceleration sensors 60a and 60b becomes approximately equal to the distance from the impact acceptance section 62b, which is the source of vibration, to each of the acceleration sensors 60a and 60b. In this case, if either of the impact acceptance section 62a or 62b is tapped on, the vibration detection values of both the acceleration sensors 60a and 60b become generally the same, thereby making it difficult to detect which of the impact acceptance section 62a or 62b has been tapped on.

In order to overcome this problem, in the present embodiment, as shown in FIG. 8, the acceleration sensors 60a and 60b and the impact acceptance sections 62a and 62b are arranged with the relative positions thereof adjusted to prevent line L1 connecting the centers of both the acceleration sensors 60a and 60b and line L2 connecting the centers of both the impact acceptance sections 62a and 62b from orthogonally crossing each other on xy plane. Consequently, there occurs a significant difference between the vibration detection values detected by both the acceleration sensors 60a and 60b, thereby suitably detecting which of the impact acceptance sections 62a and 62b has been tapped on.

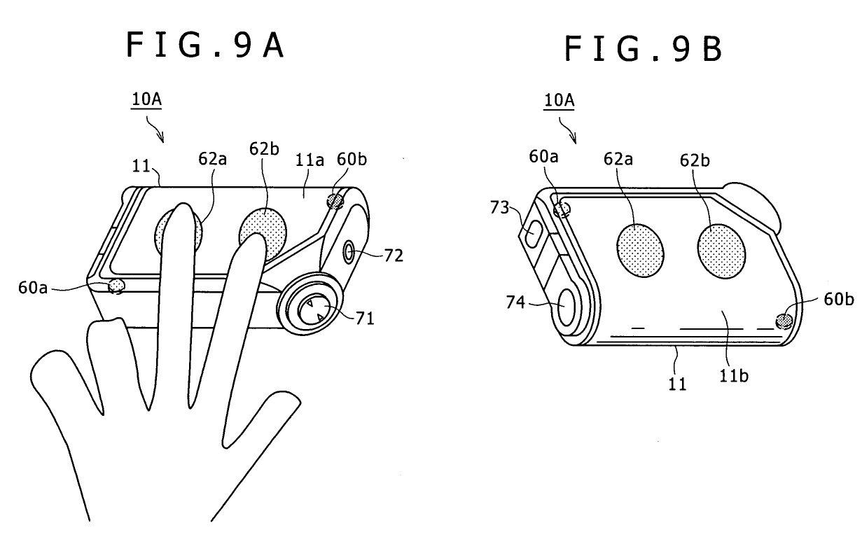

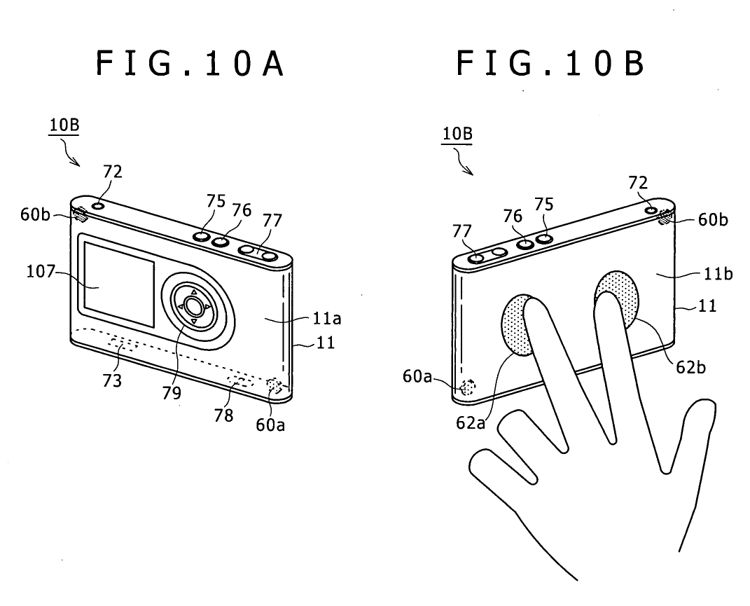

The following describes specific examples of the arrangements of the acceleration sensor 60 and the impact acceptance section 62 in the reproducing apparatus 10 with reference to FIGS. 9 and 10. FIGS. 9 and 10 are perspective views illustrating specific examples of the arrangements of the acceleration sensor 60 and the impact acceptance section 62 in the reproducing apparatus 10 practiced as one embodiment of the invention.

A reproduction apparatus 10A shown in FIG. 9 is a portable audio player of a type having no display unit 107 disposed on a housing 11 thereof. Inside the reproduction apparatus 10A, the above-mentioned acceleration sensors 60a and 60b are arranged in opposite corners. Because no display unit 107 is disposed on the housing 11 in this reproduction apparatus 10A, two impact acceptance sections 62a and 62b are arranged on both a side face 11a on the front and a side face 11b on the rear of the housing 11. Consequently, the user is able to tap on the impact acceptance sections 62a and 62b with the index finger and the middle finger for example, regardless of the front and rear sides of the reproduction apparatus 10A, thereby executing an input operation. It should be noted that the housing 11 of the reproduction apparatus 10A shown in FIG. 9 has a power button 71, an earphone terminal 72, a USB terminal 73, and a battery compartment 74.

A reproduction apparatus 10B shown in FIG. 10 is a portable audio player of a type in which a display unit 107 based on an LCD panel for example is disposed on a side face 11a on the front of a housing 11 thereof. Inside the reproduction apparatus 10B, the above-mentioned acceleration sensors 60a and 60b are arranged in opposite corners. With the reproduction apparatus 10B, two impact acceptance sections 62a and 62b are arranged only on the side face 11b, which is the rear side on which no display unit 107 is arranged. Consequently, the user is able to tap on the impact acceptance sections 62a and 62b on the rear side of the reproduction apparatus 10B with the index finger and the middle finger for example, thereby executing an input operation. It should be noted that the housing 11 of the reproduction apparatus 10B shown in FIG. 10 has an earphone terminal 72, a USB terminal 73, a menu button 75, a mode button 76, a volume control button 77, a hold switch 78 having also a power button capability, and a control button 79, for example.

The following describes a technique of identifying an input pattern on the basis of vibration analysis when two acceleration sensors 60 are arranged as described above.

In a configuration where two acceleration sensors 60 are arranged, the above-mentioned analysis block 14 is capable of analyzing the forces of the vibrations detected by the two acceleration sensors 60 to identify a position on the housing 11 to which an impact has been applied (for example, which of the impact acceptance sections 62 has been tapped on by the user), thereby determining an input pattern. For example, if the impact acceptance section 62s has been tapped on, the distance to the impact acceptance section 62a is shorter to the acceleration sensor 60a than to the acceleration sensor 60b, so that the vibration detection value of the acceleration sensor 60a becomes greater than the vibration detection value of the acceleration sensor 60b.

Therefore, the analysis block 14 makes a comparison between the vibration detection values of both the acceleration sensor 60a and 60b, thereby determining that the impact acceptance section 62a nearer to the acceleration sensor 60a having the greater vibration detection value is the source of vibration (namely, the impact acceptance section 62a has been tapped on by the user).

For example, by use of equation 1 shown below, the analysis block 14 can determine the position of a vibration source (namely, which of the impact acceptance sections 62 has been tapped on) and the force of that vibration. It should be noted that, in equation 1 below, Fa(x) denotes a vibration detection value obtained when an impact to x position of the housing 11 is detected by the first acceleration sensor 60a and Fb(x) denotes a vibration detection value obtained when an impact to x position of the housing 11 is detected by the second acceleration sensor 60b.

$$f ( x ) = \frac{Fa ( x ) - Fb ( x )}{Fa ( x ) + Fb ( x )} \qquad ( 1 )$$

If the value of f(x) expressed by above equation is a positive number, the analysis block 14 determines that the source of vibration is at position (the first impact acceptance section 62a for example) near the first acceleration sensor 60a and, if the value of f(x) is a negative number, the source of vibration is at a position (the second impact acceptance section 62b for example) near the second acceleration sensor 60b. As the absolute value of f(x) expressed by above equation (1) grows higher, it indicates that the force of the applied impact is greater (namely, the vibration is greater). Therefore, by making a comparison between the results obtained by substituting, into above equation (1), the vibration detection values of the acceleration sensors 60 obtained when two or more user input operations have been made (or the impact acceptance sections 62 have been tapped on two or more times), the analysis block 14 can determine whether the user input operations have been made at a same position or at different positions (namely, whether the same impact acceptance section 62 has been tapped on or different impact acceptance sections 62 have been tapped on).

In addition, the analysis block 14 can determine user input operations (or vibrations) having different forces to a same position (or the same impact acceptance section 62) on the housing 11 on the basis of equation (2) shown below).
g(x)=Fa(x)+Fb(x) (2)

Namely, if two user input operations have been made at x1 position and x2 position and if the values of f(x) expressed by equation (1) above are approximately the same (f(x1)≈f(x2)) and the values of g(x) expressed by equation (2) are different (g(x1)≠g(x2)), then the analysis block 14 determines that user input operations have been made at the same position (x1=x2) with different forces (namely, the same impact acceptance section 62 has been tapped on with different forces).

Thus, if two acceleration sensors 60a and 60b are arranged, the analysis block 14 can analyze the vibration detection values of both the acceleration sensors 60 to identify an input pattern made up of a combination of external impact position (namely, which of the impact acceptance sections 62 has been tapped on), external impact force, and external impact count, for example.

As with the case described above, this input pattern can be replaced two or more different types of operations (two types of button operations for example) by the user to the input unit 106. In an example in which replacement is made into an input operation of two buttons a and b, an input operation “the impact acceptance sections 62a and 62b are tapped on twice alternately” may be replaced with a button operation “a b a b.” Thus, if two acceleration sensors 60 are arranged, the analysis block 14 is able to execute the input pattern identification processing and the button operation replacement processing more easily and correctly than the case where an acceleration sensor 60 is arranged.

It should be noted that, in the above-mentioned example, two acceleration sensors 60 are arranged; it is also practical to arrange three or more acceleration sensors 60, for example. Consequently, three or more external impact positions can be detected to identify more complicated and various input patterns.

In the above-mentioned example, the detection block 12 for detecting external impacts applied to the reproducing apparatus 10 is the acceleration sensor 60; it is also practicable to arrange one or more microphones (not shown) for detecting the sound of external impacts applied to the reproducing apparatus 10, for example. Consequently, the analysis block 14 can identify an input pattern by analyzing the impact sound detected by a microphone or microphones as with the acceleration sensor 60.

2.3 Detection and Analysis Processing on the Basis of Myoelectric Sensor:

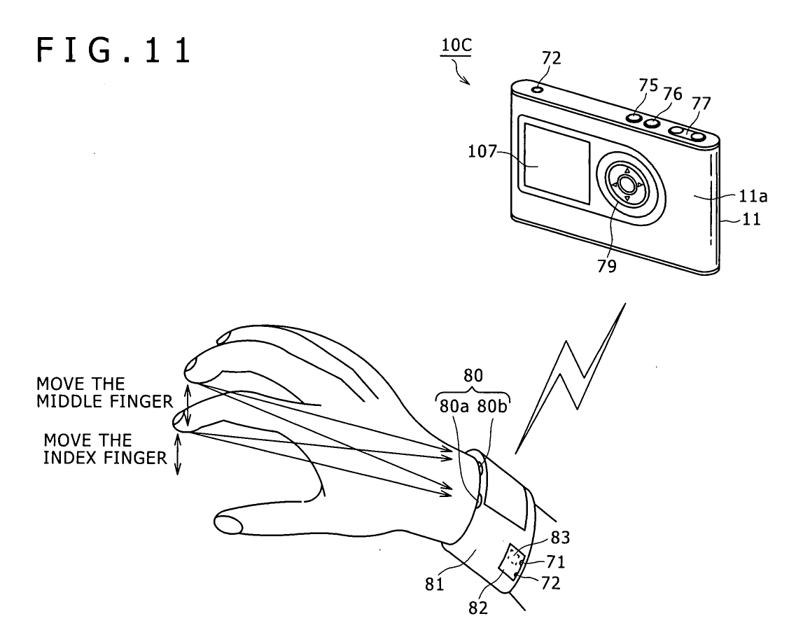

The following describes the processing of detecting and analyzing a myoelectric potential change caused by a user operation by use of a myoelectric potential change with reference to FIG. 11. FIG. 11 is a perspective view illustrating an example in which a myoelectric potential sensor 80 practiced as one embodiment of the invention is worn around the wrist of the user's arm.

As shown in FIG. 11, the user's wrist is detachably mounted with a mounting fixture 81 of wrist-band type. The mounting fixture 81 is made up of a material (a cloth belt for example) that is flexible enough for being tightly wound around the wrist. The mounting fixture 81 is detachable from the wrist by use of a mechanism based on a hook and loop fastener for example.

The mounting fixture 81 thus configured has the myoelectric potential sensor 80 (a pair of first myoelectric potential sensors 80a and second myoelectric potential sensor 80b) for example. The myoelectric potential sensor 80 is arranged on the inner face (that comes in contact with the wrist) of the mounting fixture 81, abutting upon a predetermined portion of the user's wrist. Hence, the myoelectric potential sensor 80 is capable of detecting an electric potential between the first myoelectric potential sensor 80a and the second myoelectric potential sensor 80b as a myoelectric potential.

A myoelectric potential signal detected by the myoelectric potential sensor 80 is wireless transmittable from a communication unit (not shown) arranged in the mounting fixture 81 to the main body of the reproducing apparatus 10. Alternatively, the mounting fixture 81 and the main body of the reproducing apparatus 10 may be interconnected in a wired manner to transmit myoelectric potential signals detected by the myoelectric potential sensor 80 to the reproducing apparatus 10 in a wired manner.

The mounting fixture 81 has a housing 82 in which an electronic circuit of the above-mentioned communication unit and a battery, for example, are accommodated. The housing 82 contains the power button 71, for example. Consequently, the mounting fixture 81 also functions as remote controller for controlling the power supply to the reproducing apparatus 10. The housing 82 also contains the earphone terminal 72, for example. Consequently, the user is able to plug an earphone into the earphone terminal 72 to listen to music content wirelessly transmitted from the reproducing apparatus 10 to the mounting fixture 81 and reproduced for sounding.

The myoelectric potential sensor 80 thus configured is capable of detecting a myoelectric potential change caused by the movement of user's finger. In doing so, if the user moves different fingers (the index finger and the middle finger, for example), different myoelectric potential changes are detected by the myoelectric potential sensor 80. In the case where only one finger is moved, how much the finger is moved determines a myoelectric potential change to be detected by the myoelectric potential sensor 80.

By adjusting the arrangement of the above-mentioned pair of first myoelectric potential sensor 80a and the second myoelectric potential sensor 80b, the myoelectric potential sensor 80 according to the above-mentioned embodiment is adapted to detect at least the movements of the index finger and the middle finger and the amounts of the movements, for example.

Therefore, the analysis block 14 is able to analyze, as a user input signal, the myoelectric potential change detected by the myoelectric potential sensor 80, thereby identifying a corresponding user input pattern. To be more specific, on the basis of the bodily member of the user on which a myoelectric potential change occurred (the index finger or the middle finger, for example), the magnitude of a myoelectric potential change (the amount of finger movement), the number of times the myoelectric potential changed (the number of times the finger moved), and the time interval of myoelectric potential changes (the time interval in which the finger moved), for example, the analysis block 14 analyzes a myoelectric potential signal supplied from the myoelectric potential sensor 80, thereby identifying an input pattern. This input pattern is indicative of “move the middle finger three times” or “move the index finger once widely,” for example.

Further, this input pattern can be replaced by operations of two or more different types by the user to the input unit 106 (button operations of two types of example). For example, in an example in which an input pattern is replaced by an input operation based on two buttons a and b, a pattern “the index finger and the middle finger are moved twice alternately” may be replaced by button operations “a b a b.” Such an arrangement of the myoelectric potential sensor 80 allows the analysis block 14 to easily identify an input pattern in accordance with a myoelectric potential change caused by the user's finger.

In the above description, an example is used in which the movements of the two fingers, the index finger and the middle finger, are detected by the myoelectric potential sensor 80. It is also practicable to detect the movement of only one finger or the movements of three or more fingers or the movement of any other fingers than mentioned above. It should be noted that, by making a distinction between myoelectric potential changes on the basis of the myoelectric potential change time interval and magnitude detected by the myoelectric potential sensor 80, even the detection result of a myoelectric potential change caused by the movement of even only one finger allows the acquisition of various input patterns that can be replaced by a plurality of button operations.

It should also be noted that the detection object of the myoelectric potential sensor 80 is any one of the wrist, elbow, shoulder, knee, ankle, neck or any other articulations, the face, arm, foot, toe, abdominal muscle, pectoral muscle, or any other user's body, in addition to the above-mentioned finger.

It is also practicable to arrange the myoelectric potential sensor 80 in two or more pairs of myoelectric potential sensors, rather than one pair of the myoelectric potential sensor 80a and the myoelectric potential sensor 80b as described above. This multiple pair configuration allows the detection of the movement of user finger, for example, in more complicated and various patterns, thereby increasing the number of identifiable input patterns.

If the myoelectric potential sensor 80 is used for the detection block 12, it is also practicable to arrange an electronic circuit having then entire or partial processing capabilities of the analysis block 14, the command generation block 16, and the pattern storage block 18 into the housing 82 of the mounting fixture 81, thereby making the mounting fixture 81 generate commands and transmit the generated commands to the reproducing apparatus 10 in a wired or wireless manner to instruct the reproducing apparatus 10 to execute corresponding operations.

It should be noted that the housing 11 of a reproducing apparatus 10C shown in FIG. 11 has a earphone terminal 72, a USB terminal 73, a menu button 75, a mode button 76, a volume control button 77, a hold switch 78 also functioning as a power button, and a control button 79, for example.

3. Command Generation Processing:

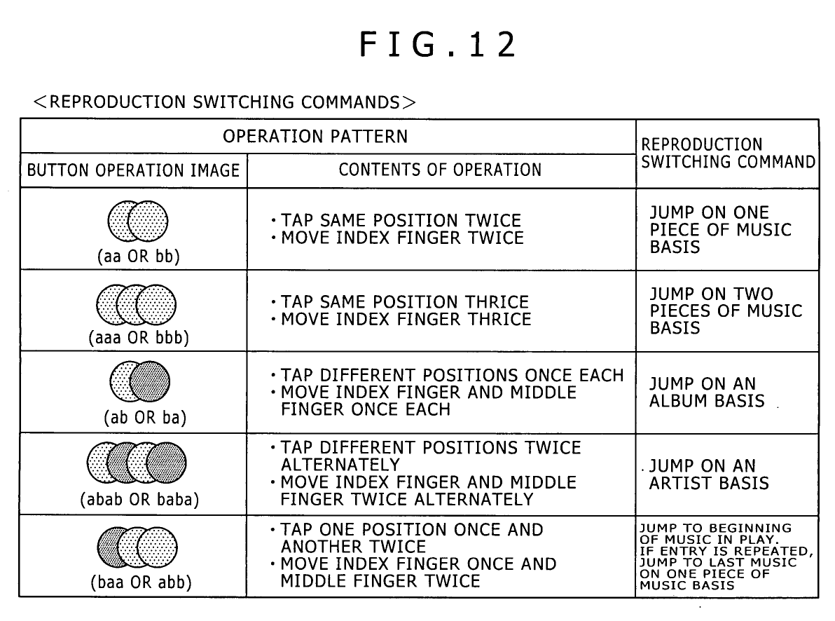

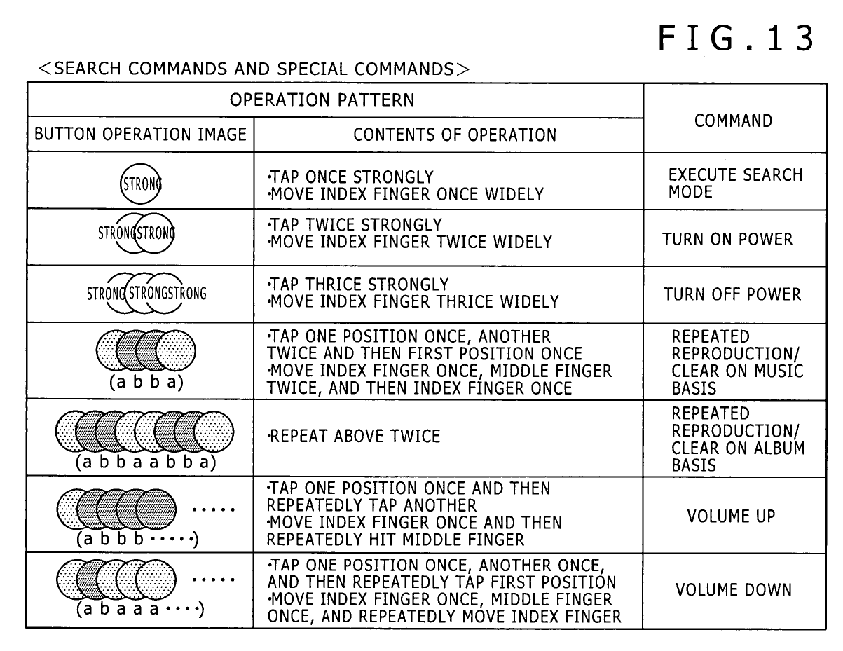

The following describes in detail the command generation processing to be executed by the command generation block 16 of the above-mentioned reproducing apparatus 10 with reference to FIGS. 12 and 13. FIG. 12 is a table indicative of a relationship between operation patterns stored in the pattern storage block 18 associated with present embodiment and reproduction switching commands. FIG. 13 is a table indicative of a relationship between operation patterns associated with the present embodiment and search commands and special commands.

As shown in FIGS. 12 and 13, the pattern storage block 18 stores tables indicative of relationships between various operation patterns and various commands (reproduction switching command, search command, and special commands) for instructing the reproducing apparatus 10 to execute various processing operations.

To be more specific, as shown in FIG. 12, a reproduction switching command instructs the reproduction control block 20 to execute various content reproduction switching (track jump) operations. To be more specific, the reproduction switching commands include commands for specifying reproduction switching operations such as “switching of music content reproduction on one title basis and on two titles basis,” “switching of music content on an album basis,” “switching of music content on an artist basis,” “switching of reproduction to the beginning of music content being reproduced,” “and switching of reproduction to the last reproduced title on one title basis,” for example. Different operation patterns are allocated in advance to these reproduction switching commands.

For example, the reproduction switch command indicative of “switching of reproduction of music content on one title basis” is allocated with an operation pattern “a position (for example, the same impact acceptance section 62 of the housing 11 of the reproducing apparatus 10) is tapped on twice” or “the index finger is moved twice.” When replaced by the above-mentioned button operation, this input pattern is “a a or b b.” The reproduction switching command indicative of “switching of reproduction of music content on an album basis” is allocated with an operation pattern “different positions (for example, the impact acceptance section 62a and the impact acceptance section 62b) of the housing 11 of the reproducing apparatus 10 are each tapped on once” or “the index finger and the middle finger are each moved once.” When replaced by the above-mentioned button operation, this input pattern is “a b or b a.” The reproduction switching command indicative of “switching reproduction of music content on an artist basis” is allocated with an operation pattern “different positions (for example, the impact acceptance section 62a and the impact acceptance section 62b) of the housing 11 of the reproducing apparatus 10 are alternately tapped on twice” or “the index finger and the middle finger are alternately move twice.” When replaced by the above-mentioned button operation, this operation pattern is “a b a b or b a b a.”

As shown in FIG. 13, the search command instructs the search block 40 to start the search mode. This search command is allocated with an operation pattern “an arbitrary position (for example, the impact acceptance section 62a) of the housing 11 of the reproducing apparatus 10 is strongly tapped on once” or “the index finger is widely moved once.”

In addition, as shown in FIG. 13, the special command instructs the reproduction control block 20 and so on to execute the processing operations other than shown above. The special commands include commands indicative of processing commands such as “turn on power to the reproducing apparatus 10,” “turn off power to the reproducing apparatus 10,” “raise audio output volume,” “lower audio output volume,” “repeat reproduction of music content on one title basis,” “repeat reproduction of music content on an album basis,” “start reproduction of music content,” “stop reproduction of music content,” “pause reproduction of music content,” “fast forward reproduction of music content,” “rewind reproduction of music content,” “and shuffle reproduction of music content,” for example. These special commands are allocated in advance with different operation patterns.

For example, the special command indicative of “turn on power to the reproducing apparatus 10” is allocated with an operation pattern “an arbitrary position (for example, the impact acceptance section 62a) of the housing 11 of the reproducing apparatus 10 is strongly tapped on twice” or “the index finger is widely move twice.” The special command indicative of “repeat reproduction of music content on one title basis” is allocated with an operation pattern “an arbitrary position (for example, the second impact acceptance section 62b) of the housing 11 of the reproducing apparatus 10 is tapped on once and then another position (for example, the first impact acceptance section 62a) is tapped on twice and then the first position is tapped on once again” or “the index finger is moved once, the middle finger is moved twice, and the index finger is moved once again.” When replaced by the above-mentioned button operations, this operation pattern is “b a a b or a b b a.” In view of returning to the first content, there is a directionality that left button a is pressed after right button b, so that “b a a b” is preferable. The special command indicative of “raise audio output volume” is allocated with an operation pattern “an arbitrary position (for example, the first impact acceptance section 62a) of the housing 11 of the reproducing apparatus 10 is tapped on once and then another position (for example, the second impact acceptance section 62b) is repetitively tapped on” or “the index finger is moved once and then the middle finger is repetitively moved.” When replaced by the above-mentioned button operations, this input pattern is “a b b b . . . ” It should be noted that, in raising or lowering the audio output volume, the raising or lowering is determined not by input count (or the number of times tapping is made) but by input time (or a duration of time in which repetitive tapping is made).

As described above, the commands for specifying the processing operations to be executed by the reproducing apparatus 10 are allocated with different operation patterns. In this allocation, as shown in the above-mentioned example, commands that are high in frequency of use by the user (for example, the reproduction switching command on a title basis, the reproduction switching command on an album basis, and the search command) during the music content reproduction by the reproducing apparatus 10 are allocated with operation patterns that are comparatively easy in input operation. This configuration allows the user to comparatively easily enter the above-mentioned commands that are high in frequency of use, thereby enhancing user convenience. It should be noted that the above-mentioned operation patterns allocated to the above-mentioned commands may be changed as desired by the user, for example.

Thus, commands and operation patterns are relatedly stored in the pattern storage block 18. The above-mentioned command generation block 16 uses the operation patterns stored in the pattern storage block 18 to generate commands in accordance with user input signals.

To be more specific, when an input pattern identified by the analysis block 14 is supplied, the command generation block 16 compares the supplied input pattern with the above-mentioned plural operation patterns stored in the pattern storage block 18 and selects the matching operation pattern. At the same time, the command generation block 16 references the above-mentioned table stored in the pattern storage block 18 to generate the commands (the above-mentioned reproduction switching command, search command, and special command, for example) indicative of the processing operations corresponding to the selected operation pattern.

Further, the command generation block 16 outputs the generated reproduction switching command and special command for example to the reproduction control block 20 to give instructions for content reproduction switching and various special processing operations by the reproducing apparatus 10. Consequently, in accordance with the type of each input command, the reproduction control block 20 executes a content reproduction switching operation and a special processing operation such as a power on/off operation. It also practicable to arrange a control block for executing the above-mentioned special processing operations separately from the reproduction control block 20. The command generation block 16 outputs the generated search command to the search block 40 to instruct the search block 40 to execute the search mode of content. In response, the search block 40 executes the search mode in accordance with the inputted search command.

4. Reproduction Switching Processing:

The following describes content reproduction switching processing by the reproduction control block 20.

When the reproducing apparatus 10 is powered on for example, the reproduction control block 20 is adapted to automatically execute the reproduction mode. In the reproduction mode, the reproduction control block 20 automatically selects two or more pieces of content stored in the content storage block 22 in accordance with a preset play list or a candidate list, thereby sequentially continuously reproducing the selected pieces of content.

In the reproducing apparatus 10 practiced as one embodiment of the invention, plural pieces of contents stored in the content storage block 22 are classified into a plurality of major categories and minor categories for management. For example, in the case of music content, the major categories may be set to the artist name of music content and the minor categories to the album name of music content. The major category of one artist contains the minor categories of one or more albums belonging to that artist and the minor category of each album contains a plurality of titles (or pieces of music) belonging to that album. This configuration allows the user to put into a hierarchy plural pieces of music content stored in the content storage block 22 on an artist name basis and an album name basis, which are attribute information of music content, for classification and management. It should be noted that a method of content classification is not restricted to the classification by content attribute; for example, plural pieces of content selected by the user may provide a minor category and a plurality of minor categories may provide a major category. Namely, any method may be used that pieces of content are put in a hierarchy by some standard for classification and management.

In this case, in the reproduction mode, the above-mentioned pieces of hierarchical music content are sequentially continuously reproduced in accordance with a play list for example. The above-mentioned list storage block 46 stores a play list created in accordance with user preference for example as a default list for use in selecting content in the reproduction mode.

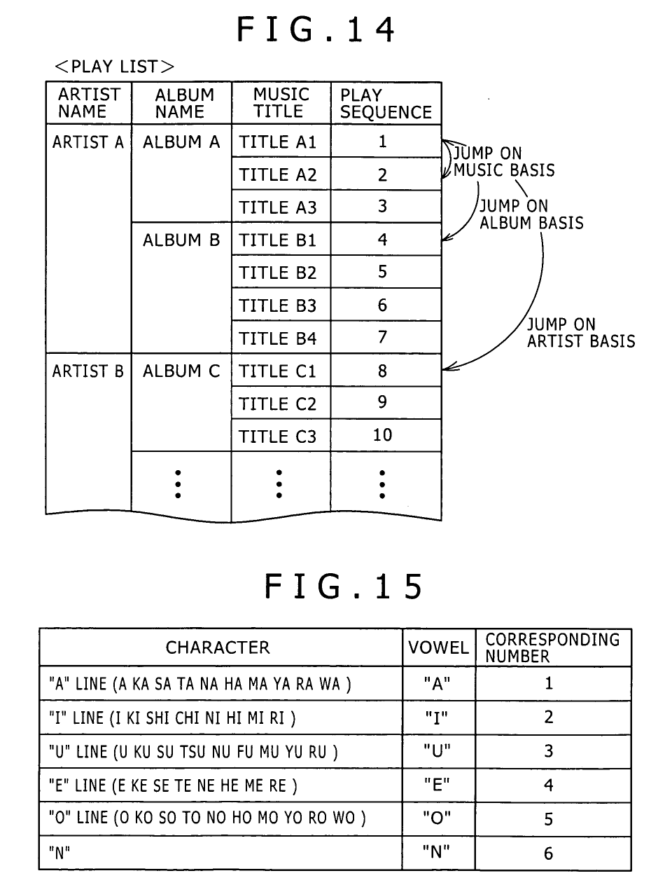

For example, with a play list shown in FIG. 14, the music content (titles) is arranged in the order of titles A1 through A3 belonging to album A of artist A, titles B1 through B4 belonging to album B of artist A, and titles C1 through C3 belonging to album C of artist B. When the reproduction mode is executed in accordance with such a play list, the reproduction control block 20 sequentially selects the pieces of music content ranking high in that play list and instructs the reproduction block 30 to reproduce the selection.

If a reproduction switching command is issued from the above-mentioned command generation block 16 during the execution of the reproduction mode, the reproduction control block 20 executes a reproduction switching operation as instructed by that reproduction switching command. Namely, the reproduction control block 20 switches the pieces of content to be reproduced on a title basis, on an album basis (or on a minor category basis), or on an artist basis (or on a major category basis) in accordance with the type of the supplied reproduction switching command.

For example, if “reproduction switching command on one title basis” is entered during the reproduction of music content (title A1) in album A (minor category) of artist A (major category), the reproduction control block 20 track-jumps (or reproduction-switches) to next piece of music content (title A2) in the same album A as the music content (title A1) being reproduced.

If “reproduction switching command on an album basis” is entered during the reproduction of above-mentioned music content (title A1), the reproduction control block 20 track-jumps to a first piece of music content (title B1) in next album B of the same artist A as the music content (title A1) being reproduced. Consequently, when selecting a different album in a hierarchical structure, “reproduction switching command on an album basis” allows a jump directly to a different album without returning to the upper category (for example, returning from a minor category to a major category to select a different minor category).

If “reproduction switching command on a album basis” is entered during the reproduction of music content (one of titles B1 through B4) in the last album B of artist A, the reproduction control block 20 track-jumps to the first piece of music content (title A1) in the first album A of artist A to reproduce this title. In this case, a track jump may be made to the first piece of music content (title C1) in the first album C of next artist B different from artist A.

If “reproduction switching command on an artist basis” is entered during the reproduction of the above-mentioned music content (title A1), the reproduction control block 20 track-jumps to the first piece of music content (C1) in the first album C of artist B different from artist A of the music content (title A1) being reproduced.

The play list for use in the above-mentioned reproduction mode may be an artist list of user preference, for example. This artist list of user preference may be created by preferentially arranging artists on the basis of the past reproduction frequency of albums of these artists.

In response to the input of the above-mentioned “reproduction switching command on an artist basis,” the reproduction control block 20 is capable of executing content reproduction switching on an artist basis in accordance with the priority in the user-preference artist list. To be more specific, if the above-mentioned “reproduction switching command on an artist basis” is entered, the reproduction control block 20 switches reproduction to the music content of an artist of top priority and, if “reproduction switching command on an artist basis” is entered again later, switches reproduction to the music content of an artist having a next higher priority, thereby executing track jumps in the order of artists of higher priorities. This allows the quick reproduction of the music content of artists of user preference through the efficient track jumps in accordance of user preference.

5. Search Processing:

The following describes the search processing to be executed in the search mode of the reproducing apparatus 10 practiced as one embodiment of the invention.

As described above, the name storage block 42 stores, as the names associated with the music content stored in the content storage block 22, the name data (one type of content attribute information) indicative of the titles, albums and artists of the music content, for example. In response to user input operations, the reproducing apparatus 10 practiced as one embodiment of the invention is capable of searching for the name data associated with the music content. Consequently, by switching the reproduction of content in unit of the retrieved name data, the reproducing apparatus 10 is capable of quickly selectively reproducing user-desired content.

First, a search technique will be outlined. The Japanese language has five vowels “a,” “i,” “u,” “e,” and “o.” Therefore, as shown in FIG. 15, the Japanese letters are allocated to these five vowels in accordance with pronunciations thereof. Namely, letters of “a” line, “a, ka, sa, ta, na, ha, ma, ya, ra, and wa,” are allocated to vowel “a”; letters of “i” line, “i, ki, shi, chi, ni, hi, mi, and ri” are allocated to vowel “i”; letters of “u” line, “u, ku, su, tsu, nu, fu, mu, yu, and ru,” are allocated to vowel “u”; letters of “e” line, “e, ke, se, te, ne, he, me, and re,” are allocated to vowel “e”; and letters of “o” line, “o, ko, so, to, no, ho, mo, yo, ro, and wo,” are allocated to vowel “o.” Likewise, voiced consonants (“ga” and so on) and semi-voiced consonants (“pa” and so on) are allocated to the five vowels. Although “n” is a consonant, it is exceptionally handled as “n” without change. However, it is also practicable not to handle this “n” as a letter at the time of each search operation.

Further, the vowels and “n” are associated with different numbers. For example, as shown in FIG. 15, vowel “a” is associated with number “1,” vowel “i” with number “2,” vowel “u” with number “3,” vowel “e” with number “4,” vowel “o” with number “5,” and “n” with number “6.”

Thus, all Japanese words subject to search can be converted into vowel names (vocalized) and then into number strings each composed of 1 through 6.

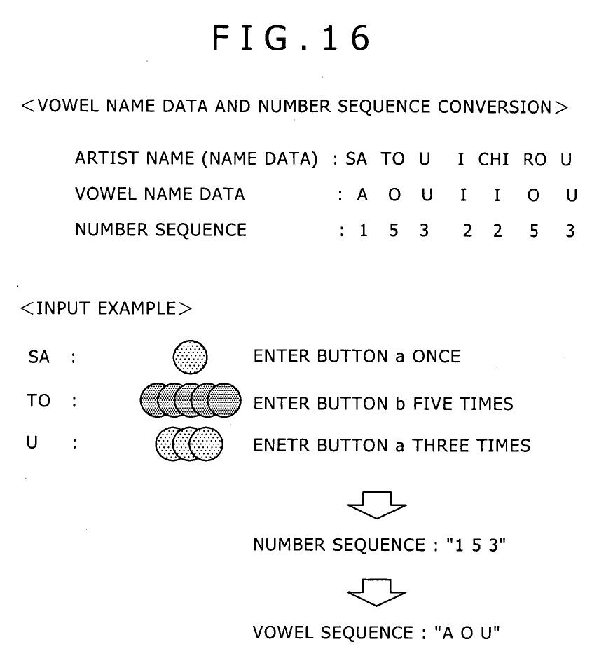

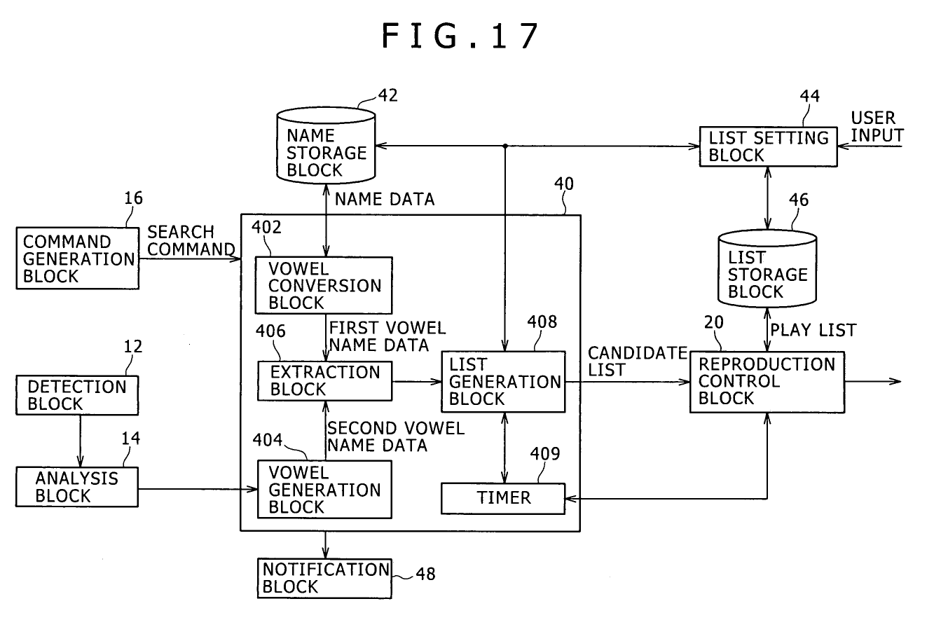

For example, as shown in FIG. 16, name data “Satou Ichirou” indicative of an artist name can be vocalized into vowel name data “a o u i i o u” and then into number string “153 2253.” Here, an example is used in which an artist name is converted as name data; it is also practicable to convert name data such as a title name and an album name for example of music content into vowel name data and number strings in the same manner as described above.

It should be noted that an English name for example may be vocalized by reading it in a Romanized manner. To be more specific, in order to vocalize artist name “Telephone,” the name may be read in a Romanized manner, such as “te re fo n,” thereby vocalizing into “e e o n.” In other methods of vocalizing English names, only letters “a,” “i,” “u,” “e” and “o” are extracted from English names (for example, in the above-mentioned case of “Telephone,” alphabets “e,” “e,” and “o” are extracted to be vocalized into “e e o”) and English pronunciation symbols are handled as vowels, for example.

In the above description, sounds “a” through “o” are allocated to numbers “1” through “5” for search processing. It is also practicable to two or more sounds may be associated with two or more numbers for inputting. For example, in the allocation of two or more consonants to numbers, the sounds in the 50-character Japanese syllabary are allocated to “1” through “10”; “a i u e o” to “1,” “ka ki ku ke ko” to “2,” “sa shi su se so” to “3,” and so on. Therefore, “Satou Ichirou” may be entered as “341 1491.”

As described above, the vocalization and number sequencing of names allow simple and quick search processing by entering a character sequence corresponding to the above-mentioned vowel name data when the user searches for the music content to be reproduced in the reproducing apparatus 10 by use of the name data such as title name, album name, and artist name, for example.

For example, in the search of the music content of an artist called “Satou Ichirou,” the user may only enter “153 2253.” If a number “1” to “6” is entered n times, the probability in which the same result is obtained is ⅙ⁿ. Hence, for example, in the search of artist name “Satou Ichirou,” entering only “153” corresponding to family name “Satou” brings about the probability of retrieving other than “a o u” obtained by vocalizing “Satou” is ⅙³= 1/216, thus making it highly possible to identify “Satou Ichirou.”

Therefore, the processing of searching for name data such as artist names for example can be realized by means of a simple operation in which the analysis block 14 analyzes a user input signal detected by the detection block 12 to identify an input pattern and the identified input pattern is converted into a number sequence to provide vowel name data. For example, as shown in FIG. 16, in the search for the above-mentioned name “Satou” by means of button operations based on the above-mentioned two buttons a and b for example, pressing button a once, button b five times, and button a three times can enter number sequence “153” corresponding to “a o u” obtained by vocalizing “Satou,” thereby giving an instruction for searching for an artist name corresponding to “a o u.”

The following describes in detail an exemplary configuration of the search block 40 for executing the search processing by use of the above-mentioned name data vocalization technique, with reference to FIG. 17. FIG. 17 is a block diagram illustrating a functional configuration of the search block 40 of the reproducing apparatus 10 practiced as one embodiment of the invention.

As shown in FIG. 17, when a search command is entered from the command generation block 16, the search block 40 searches the name data stored in the name storage block 42 to create a candidate list indicative of a name data search result, which is then outputted to the reproduction control block 20. The search block 40 has a vowel conversion block 402, a vowel generation block 404, an extraction block 406, a list generation block 408, and a timer 409.

The vowel conversion block 402 converts plural pieces of name data stored in the name storage block 42 into first vowel name data. To be more specific, as described above, the name storage block 42 stores the name data such as the title, album name, and artist name of each piece of music content. The vowel conversion block 402 reads plural pieces of name data from the name storage block 42 and converts each piece of name data into the first vowel name data. This vowel conversion processing is executed by the name vocalization technique described above with reference to FIGS. 15 and 16.

In the above-mentioned vowel conversion, it is efficient to convert only the name data that corresponds to the name subject to search, of all or part of the title name, album name, and artist name of the above-mentioned music content. In what follows, the vowel conversion block 402 vowel-converts two or more artist names stored in the pattern storage block 18 into the first vowel name data. In addition, the vowel conversion block 402 outputs the resultant first vowel name data to the extraction block 406.

It should be noted that, in the above-mentioned conversion processing by the vowel conversion block 402, the name data may be read from the name storage block 42 after the execution of the search mode to be converted into the first vowel name data. Alternatively, the vowel conversion block 402 may convert the name data read from the name storage block 42 into the first vowel name data in advance before the execution of the search mode (during the reproduction mode for example), thereby storing the resultant first vowel name data into the name storage block 42 for example. The conversion beforehand allows the vowel conversion block 402, in the execution of the search mode, to read plural pieces of the first vowel name data after conversion from the name storage block 42 and output the these pieces of data to the extraction block 406 without change, thereby saving repetitive conversion operations for efficient conversion processing.

The vowel generation block 404 generates the second vowel name data corresponding to the input pattern identified by the above-mentioned analysis block 14 and outputs the generated second vowel name data to the extraction block 406.

To be more specific, when the search mode has been executed, the user executes, to the reproducing apparatus 10, an input operation so as to indicate the vowel name of a desired name (an artist name for example) subject to search. This input operation is executed by applying an external impact to the reproducing apparatus 10 by tapping the housing 11 of the reproducing apparatus 10 or causing a myoelectric potential change by moving a finger of the arm on which the myoelectric potential sensor is installed, for example. For example, when making a search for the above-mentioned name “Satou,” if the acceleration sensor 60 is used for example, the user taps once on the impact acceptance section 62a (equivalent to button a) of the housing 11 of the reproducing apparatus 10, taps on the impact acceptance section 62b (equivalent to button b) five times, and taps on the impact acceptance section 62a three times. When the myoelectric potential sensor 80 is used, the user moves the index finger once, the middle finger five times, and the index finger three times. Such input operations allow the user to enter number sequence “153” corresponding to vowel name “a o u” obtained by vocalizing “Satou.”

Then, the detection block 12 made up of the acceleration sensor 60 or the myoelectric potential sensor 80 detects the above-mentioned external impact or myoelectric potential change corresponding to the input operation done, as a user input signal. Further, on the basis of the information indicative of the position and count of the external impact or myoelectric potential change contained in that user input signal, for example, the analysis block 14 analyzes the user input signal to identify an input pattern. This input pattern is indicative of a number sequence corresponding to a name subject to search as described above. The analysis block 14 outputs the input pattern thus identified to the vowel generation block 404.

As a result, the vowel generation block 404 converts the input pattern supplied from the analysis block 14 into a number sequence and then converts the number sequence into a vowel sequence to generate the second vowel name data. To be more specific, as shown in FIG. 16, the vowel generation block 404 first analyzes an input pattern indicative of the number of times external impacts have been applied or the number of times myoelectric potential changes have occurred (or the number of times buttons a and b have been pressed) in accordance with a user input operation to convert the analyzed input pattern into number sequence such as “153” for example. Then, the vowel generation block 404 converts each number contained in the obtained number sequence “153” into a corresponding vowel, thereby converting the number sequence “153” into vowel sequence “a o u.” The vowel generation block 404 outputs the obtained vowel sequence “a o u” to the extraction block 406 as the second vowel name data.

Further, for example, the vowel generation block 404 outputs the second vowel name data thus generated also to the notification block 48. The notification block 48 notifies the user of the second vowel name data. In this notification processing, the vowel sequence (“a o u” for example) of the second vowel name data may be displayed on the display unit 107 or audibly outputted from the audio output unit 110, for example. This notification processing allows the user to confirm whether the input operation done by himself has been correct for searching for desired names.

The extraction block 406 compares plural pieces of first vowel name data entered from the vowel conversion block 402 with one piece of second vowel name data entered from the vowel generation block 404. Further, on the basis of a result of this comparison, the extraction block 406 extracts one or more pieces of first vowel name data that matches or is similar to the above-mentioned second vowel name data from among the above-mentioned plural pieces of first vowel name data and outputs the extracted first vowel name data to the list generation block 408.

In this comparison and extraction processing, to be compared is a letter sequence (first three letters for example) corresponding to the number of letters (three for example) of the second vowel name data of the letter sequence of the first vowel name data, for example. Further, on the basis of this comparison result, the extraction block 406 extracts one or more pieces of first vowel name data that matches or is similar to the above-mentioned second vowel name data from the above-mentioned plural pieces of first vowel name data and outputs the extracted first vowel name data to the list generation block 408.

In this comparison and extraction processing, only the first vowel name data (“a o u” for example) that matches the above-mentioned second vowel name data (“a o u” for example) may be extracted, for example. This enhances the correctness of search processing, thereby lowering search noise.

Alternatively, in the above-mentioned comparison and extraction processing, not only the first vowel name data matching the above-mentioned second vowel name data (“a o u” for example) but also the first vowel name data (“a o i” for example) that is similar with a predetermined similarity may be extracted. The above-mentioned “similar with a predetermined similarity” denotes that the first vowel name data and the second vowel name data match each other in the number of letters equal to or higher than a predetermined ratio (75% for example) of the entire number of letters of the second vowel name data, for example. Thus, if the similar vowel name data is also extracted, user input errors (for example, the reproducing apparatus 10 has been tapped one more time than specified or the finger has been moved one more time than specified) can be compensated.

It should be noted that the extraction block 406 associated with the present embodiment makes a comparison between the first vowel name data and the second vowel name data; it is also practicable for the extraction block 406 to make a comparison between the number sequence corresponding to the first vowel name data and the number sequence corresponding to the second vowel name data, for example. In this case, the extraction block 406 can convert the first vowel data obtained by the vowel conversion block 402 into a number sequence and, by receiving a number sequence corresponding to the second vowel name data from the vowel generation block 404, make a comparison between both the number sequences.

The list generation block 408 puts into a list the name data corresponding to the first vowel name data extracted by the extraction block 406, thereby creating a candidate list. This candidate list is a list indicative of a result of the search processing executed by the search block 40 and includes one or more pieces of name data that matches or is similar to the user-entered name data subject to search.

To be more specific, also after conversion of the name data read from the name storage block 42 into the first vowel name data, the vowel conversion block 402 stores the name data of the conversion source and the first vowel name data after conversion by relating them each other, for example. For example, the vowel conversion block 402 may store in the name storage block 42 the name data before conversion and the first vowel name data after conversion by relating them with each other or temporarily store them in the buffer 103 for example. Therefore, when one or more pieces of vowel name data are entered from the extraction block 406, the list generation block 408 can read from the name storage block 42 for example the name data of the conversion source of the first vowel name data (for example, “a o u i i o u”) and acquire the read name data (for example, “Satou Ichirou”).

Consequently, the list generation block 408 can put the name data (an artist name for example) of the conversion source of the above-mentioned extracted first vowel name data into a list, thereby creating a candidate list (a candidate artist list for example).

A the time of candidate list creation, the list generation block 408 arranges the artist names of the conversion source of the extracted first vowel name data in a sequence corresponding to the similarity (the ratio of number of matching letters for example) between the first vowel name data and the second vowel name data compared by the extraction block 406, for example, thereby creating a candidate artist list, for example.

Consequently, one or more artist names (for example “Satou Ichirou,” “katou Junichirou,” “Satou Tarou”) corresponding to the first vowel name data (for example “a o u OOOO”) matching the second vowel name data (for example, “a o u”) subject to search are arranged on top of the candidate artist list. Immediately below the top, one or more artist names (for example, “Satoi Jirou” and “Satomi Daisuke”) corresponding to the first vowel name data (for example, “aoi OOOO”) similar to the second vowel name data (for example, “a o u”) are arranged in a sequence according to the similarity.

Thus, the list generation block 408 creates a candidate list indicative of a result of the search processing executed by the search block 40 and outputs the created candidate list to the reproduction control block 20. The timer 409 counts a time elapsed from the creation of each candidate list by the list generation block 408 or a time elapsed from the starting of content reproduction in accordance with the candidate list.

As described above, the search block 40 searches for user desired names and outputs a candidate list containing retrieved names to the reproduction control block 20. The reproduction control block 20 controls the reproduction block 30 so as to sequentially continuously reproduce the content stored in the content storage block 22 in accordance with the candidate list supplied from the list generation block 408.

As described above, in the normal reproduction mode, the reproduction control block 20 sequentially reproduces two or more pieces of content in accordance with the above-mentioned play list. However, during a predetermined period of time after the end of the search mode, the reproduction control block 20 executes control such that plural pieces of content corresponding to one or more titles, albums, or artists contained in the above created candidate list are sequentially reproduced. In doing so, if the candidate list contains one or more albums or artist names, the reproduction control block 20 executes control such that the music content belonging to an album name or artist name in a random sequence or in a preset sequence (for example, by use of the artist part in the above-mentioned play list), for example.

Further, the reproduction control block 20 switches the pieces of music content to be reproduced, on a title basis, an album basis, or an artist basis in accordance with the above-mentioned candidate list. To be more specific, if a reproduction switching command is entered from the command generation block 16 when music content is being continuously reproduced in accordance with a candidate list as described above, the reproduction control block 20 switches the pieces of music content to be reproduced in a sequence of titles, albums, or artists listed in the candidate list. For example, if a command for switching music content on an artist basis is entered, the reproduction control block 20 track-jumps to the music content of a next artist in the candidate list and reproduces that music content.

The reproduction switching (namely, a track jump) in accordance with a candidate list allows the user to sequentially previewing the music content after reproduction switching, thereby retrieving the pieces of music content belonging to a user-desired name (for example, an artist name) from the candidate list containing plural names (for example, plural artist names) as a result of the above-mentioned search processing.

Further, if the elapsed time counted by the timer 409 is within a predetermined search extension time, then, because the search mode is still on, the reproduction control block 20 switches the pieces of music content to be reproduced in accordance with the above-mentioned candidate list. On the other hand, if the elapsed time counted by the timer 409 is outside the above-mentioned search extension time, then, because the search mode ended and the normal reproduction mode is now on, the reproduction control block 20 switches the pieces of music content to be reproduced in accordance with a play list set by the list setting block 44 beforehand and stored in the list storage block 46.

Thus, if the elapsed time counted by the timer 409 is within the above-mentioned predetermined search extension time (three minutes for example), it indicates that not much time has passed since the creation of a candidate list or the starting of content reproduction based on a candidate list. At this moment, it is possible that the user is halfway in searching for the content of a desired artist by executing content switching operations several times to sequentially switching the content subject to reproduction on an artist basis in a candidate list obtained as a result of the above-mentioned search processing, for example.

Therefore, if the timer 409 is indicative of a time that is within the above-mentioned predetermined search extension time, the reproduction control block 20, so as to allocate a search time by the user, executes reproduction in accordance with a candidate list without ending the search mode. On the other hand, if the timer 409 is indicative of a time that is without the above-mentioned predetermined search extension time, the reproduction control block 20 executes reproduction in accordance with a predetermined play list. It should be noted that the above-mentioned predetermined search extension time is set to a time (three minutes for example) necessary for the user to sequentially switching the pieces of content subject to reproduction for preview, thereby searching for the content corresponding to the name data subject to search from among plural pieces of name data in a candidate list.

Thus, a configuration of the search block 40 according to the present embodiment and a technique of controlling the reproduction of content according to a result of the processing executed by the search block 40 have been described in detail.

According to the above-described search processing, search processing can be executed for the names associated with the content stored in the reproducing apparatus 10 by use of vowel name data, thereby efficiently executing search operation and simplifying search keywords to be entered. Consequently, even a simple input operation, such as tapping the housing 11 of the reproducing apparatus 10 with a finger or moving a finger of the arm on which the myoelectric potential sensor 80 is installed, can obtain necessary search results. This novel configuration will significantly save the time and labor for user input operations necessary for executing search processing. At the same time, the novel configuration can search for similar name data, thereby compensating user input errors.

Further, the reproduction switching on the basis of a candidate list obtained as a result of search processing allows the user to find the content having a desired name from one or more candidate names obtained as a result of search processing only by sequentially viewing the pieces of content subject to reproduction switching without viewing search results on the display unit 107 for example of the reproducing apparatus 10.

Thus, use of the reproducing apparatus 10 according to the present embodiment allows the user to give content search commands and check search results only by executing a small and simple operation of moving his fingers. The novel configuration is especially useful in making search operations in an environment (inside a crowded train for example) in which it is difficult for the user to take out the reproducing apparatus 10 for operation or view images displayed on the display unit 107, for example.

In the above description, an example is used in which the search block 40 executes search processing mainly by use of artist names and outputs a candidate artist list as a search result; it is also practicable for the search block 40 to execute search processing by use of a title of music content to output a candidate title list as a result of the search processing and for the reproduction control block 20 to execute reproduction switching on a content basis (namely, a track jump on a title basis) in accordance with this candidate title list. Alternatively, it is practicable for the search block 40 to execute search processing by use of an album name of music content to output a candidate album list as a result of the search operation and for the reproduction control block 20 to execute reproduction switching on an album basis (namely, a track jump on an album basis) in accordance with this candidate album list.

6. Basic Processing Flow of the Reproduction Apparatus:

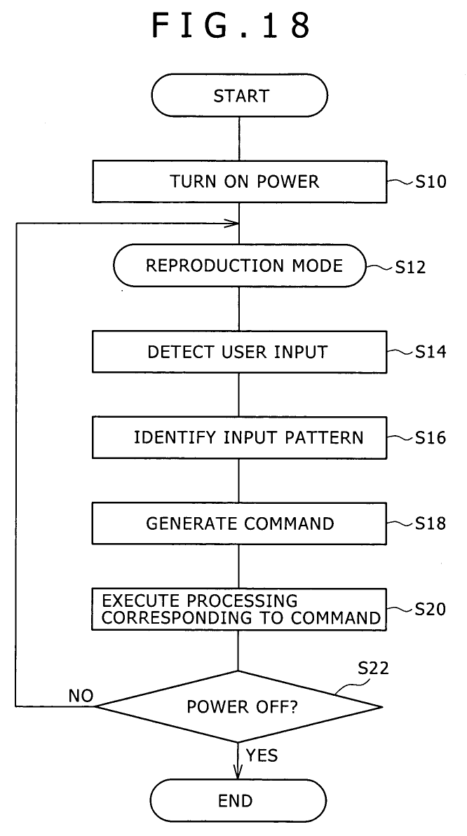

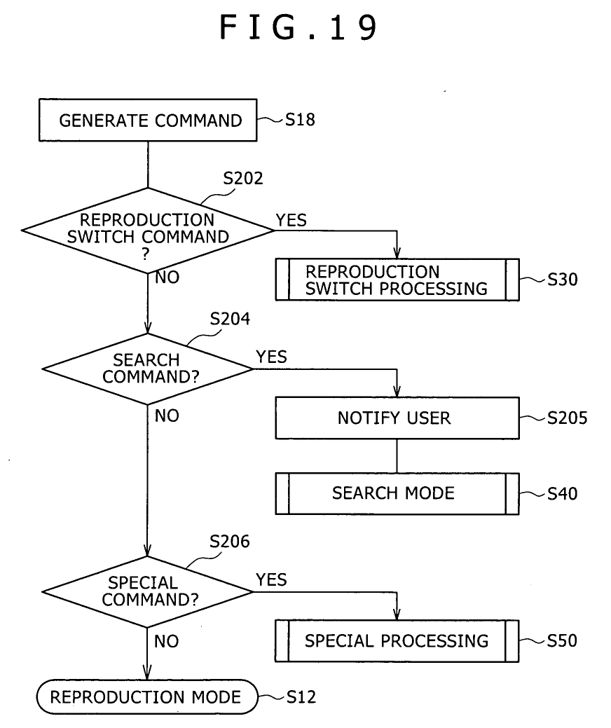

The following describes a processing flow of the reproducing apparatus 10 practiced as one embodiment of the invention. First, a basic processing flow in the reproducing apparatus 10 will be described with reference to FIGS. 18 and 19. FIG. 18 is a flowchart indicative of a basic processing flow in the reproducing apparatus 10. FIG. 19 is a flowchart outlining a processing flow in accordance with command types in the reproducing apparatus 10.

As shown in FIG. 18, in step S10, the reproducing apparatus 10 is powered on by the user. For example, when a power button 71 (refer to FIGS. 4, 7 and 9) of the reproducing apparatus 10 is pressed, the power is supplied to the reproducing apparatus 10. It should be noted that the power button 71 also functions as a button for power on/off switching (for example, the power button 71 is kept pressed in the power-on status, the power to the reproducing apparatus 10 is turned off), starting reproduction (the power button 71 is pressed once again in the power-on status), and stopping reproduction (the power button 71 is pressed during the reproduction mode).

In step S12, the reproduction mode is executed by the reproducing apparatus 10. For example, when the reproducing apparatus 10 is powered on (or when the reproduction button is pressed or the power button 71 is pressed again), the reproducing apparatus 10 automatically executes the above-mentioned reproduction mode to start reproduction from the beginning of the music content reproduced in the last reproduction, thereby sequentially continuously reproducing the music content in accordance with a preset play list. Thus, the reproducing apparatus 10 is executing the reproduction mode in which music content is continuously reproduced when the power is on and unless a special user input operation is made. In view of a user input operation wait status, this reproduction mode is a standby mode.

In step S14, if a user input operation is executed on the reproducing apparatus 10 in the above-mentioned reproduction mode, the detection block 12 detects a user input signal generated when the user input operation is made. For example, when the user taps on the impact acceptance section 62 on the housing 11 of the reproducing apparatus 10 to give an external impact to the reproducing apparatus 10, a vibration caused by the impact is picked up by the acceleration sensor 60 for example as a user input signal. Alternatively, when the user moves one of his fingers of the wrist attached with the myoelectric potential sensor 80, a myoelectric potential change on the wrist is detected by the myoelectric potential sensor 80 as a user input signal.

Then, in step S16, the analysis block 14 analyzes the user input signal detected in step S14 to identify an input pattern. For example, the analysis block 14 analyzes the user input signal on the basis of the force, time interval, position and count of the external impact or the myoelectric potential change contained in the detected user input signal, thereby identifying an input pattern corresponding to the user input operation. This input pattern can be replaced by two button operations a and b for example as described before.

In step S18, the command generation block 16 generates a command corresponding to the input pattern identified in step S16. To be more specific, the command generation block 16 makes a comparison between the input pattern identified in step S16 and a plurality of operation patterns stored in the pattern storage block 18 to identify a matching operation pattern. In addition, the command generation block 16 generates a command for executing a processing operation corresponding to the identified operation pattern and outputs the generate command to associated components (the reproduction control block 20 and the search block 40 for example) of the reproducing apparatus 10. It should be noted that, if no operation pattern matching the input pattern is found set in step S18, then it is determined that the user input operation has an error, upon which error messaging is executed for example, thereby continuing the above-mentioned reproduction mode (step S12).

In step S20, the associated components of the reproducing apparatus 10 execute processing operations corresponding to the command generated in step S18. The following describes the processing of step S20 with reference to FIG. 19.

The above-mentioned command is classified into a command for executing content reproduction switching (or a track jump), a command for executing the search mode, and a command for executing other processing operations (power-off for example) (refer to FIGS. 12 and 13).

As shown in FIG. 19, if the command generated as described above in step S18 is a reproduction switching command (step S202), the reproducing apparatus 10 executes reproduction switching (step S30). If the above-mentioned command is a search command (step S204), then the reproducing apparatus 10 notifies the user of the execution of the search mode audibly or visibly for example (step S205) and then executes the search mode (step S40). If the above-mentioned command is a special command (step S206), then the reproducing apparatus 10 executes a special processing accordingly (step S50). It should be noted that if none of the above-mentioned commands is applicable, then the procedure returns to step S12 to continue the reproduction mode.

Referring to FIG. 18 again, if the power is not off (step S22) after the processing of step S20, then the procedure returns to step S12 to continue the reproduction mode, thereby sequentially continuously reproducing the content. If the power is off (step S22), all the processing of the reproducing apparatus 10 is ended.

7. Flow of Reproduction Switching Processing:

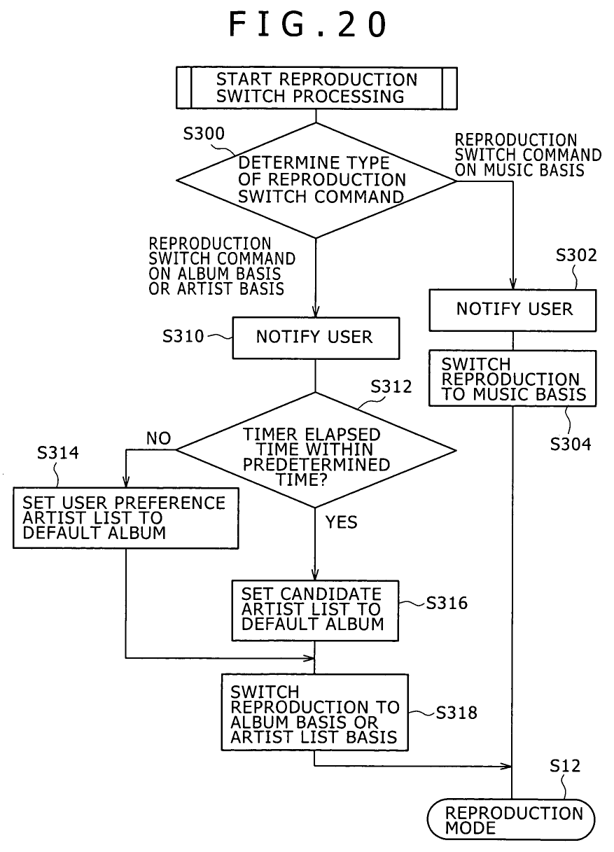

The following describes a detail flow of the reproduction switching processing (step S30 of FIG. 19) to be executed in the reproducing apparatus 10 with reference to FIG. 20. FIG. 20 is a flowchart indicative of a reproduction switching processing flow (or a reproduction control method) in the reproducing apparatus 10.

As shown in FIG. 20, in outline, first a type of the reproduction switching command is determined (step S300). If the reproduction switching command is found to be a reproduction switching command on a title basis, reproduction switching is executed on a title basis (step S304). If the reproduction switching command is found to be a reproduction switching command on an album or artist basis, reproduction switching is executed on an album or artist basis (step S318) and then the procedure returns to the reproduction mode (step S12). This reproduction switching on an album or artist basis is characterized by that reproduction switching is executed in accordance with an artist list of user preference (step S314), one of existing play lists, or reproduction switching is executed in accordance with a candidate list created in the search mode (step S316) depending upon an elapsed time counted by the above-mentioned timer 409. The following describes in detail the steps making up this reproduction switching processing.

First, in step S300, the reproduction control block 20 determines the type of a reproduction switching command generated in step S18 shown in FIG. 18. To be more specific, the reproduction control block 20 determines whether the entered reproduction switching command is a command for executing reproduction switching on a music content title basis, album basis, or artist basis.

If the entered reproduction switching command is found to be a command for executing reproduction switching on a title basis, then the procedure goes to step S302, in which the notification block 48 notifies the user of the execution of the reproduction switching on a title basis (step S302). It should be noted that this notification need not always executed.

In step S304, the reproduction control block 20 reproduction-switches the music content subject to reproduction on a title basis (or track-jumps on a title basis) (step S304). For example, if “reproduction switching command on one title basis” is entered during the execution of the reproduction mode according to a play list as shown in FIG. 14, the reproduction control block 20 reproduction-switches to next music content (title A2) in the same album A as the music content (title A1) being reproduced. As a result, the reproduction block 30 starts reproduction from the beginning of the music content (title A2) after switching, returning to the reproduction mode (step S12). It should be noted that, if a reproduction switching command on a two or more titles basis is entered, the reproduction control block 20 reproduction-switches on a two or more titles basis (or track-jumps on a two titles basis for example).

On the other hand, if the entered command is found to be a reproduction switching command on an album or artist basis in step S300, then the procedure goes to step S310, in which the notification block 48 notifies the user of the execution of reproduction switching on an album or artist basis. It should be noted that this notification processing need not always be executed.

Next, in step S312, the reproduction control block 20 determines whether an elapsed time counted by the timer 409 is within the above-mentioned predetermined search extension time. As described above, after the execution of the search mode by the search block 40, an elapsed time since the creation of a candidate list or the start of reproduction of music content according to a candidate list is counted by the timer 409. If this elapsed time is within a predetermined search extension time (three minutes for example), it indicates that the user is searching for a desired artist for example by use of the candidate list, so that the candidate list must be kept in the effective status.

If the elapsed time counted by the timer 409 is found exceeding the above-mentioned search extension time as a result of the decision of step S312 or no elapsed time has been counted by the timer 409, the reproduction control block 20 sets an existing play list, an artist list of user preference for example, as default list by which reproduction control is executed on an album basis or on an artist basis (step S314). This artist list of user preference may be created by extracting the artist part of play lists so far used for the reproduction mode or by arranging the artists of user preference in a sequence of higher reproduction frequency on the basis of user input or album-basis reproduction frequency, for example.

On the other hand, if the elapsed time counted by the timer 409 is found within the above-mentioned search extension time as a result of the decision of step S312, then the reproduction control block 20 sets a candidate list created by the search block 40, a candidate artist list for example, as the default list (step S316).

Next, in step S318, the reproduction control block 20 preproduction-switches the music content subject to reproduction on an album basis or on an artist basis (or a track jump on an album or artist basis) in accordance with the default list set as described above.

For example, it is assumed that a general play list as shown in FIG. 14 be set as the default list in step S314. In this case, when “reproduction switching command on an album basis” is entered during the execution of the reproduction mode, the reproduction control block 20 track-jumps to the first music content (title B1) in the album B next to the same artist A as the music content (title A1) being reproduced and reproduces title B1. Consequently, the reproduction block 30 starts reproducing the music content (title B1) after switching from the beginning and returns to the above-mentioned reproduction mode (step S12). If “reproduction switching command on an artist basis” is entered, for example, the reproduction control block 20 track-jumps to the first music content (title C1) of the first album C of the next artist B different from artist A of the music content (title A1) being reproduced and reproduces title C1. Consequently, the reproduction block 30 starts reproducing the music content (title C1) after switching from the beginning and returns to the above-mentioned reproduction mode (step S12).

On the other hand, if a candidate list is set as the default list in step S316, then the reproduction control block 20 reproduction-switches the music content subject to reproduction on an album basis or on an artist basis in accordance with the candidate artist list set as described above. Consequently, the user is able to preview the music content of desired artists in the candidate artist list obtained by the search processing, thereby retrieving the content of the desired artist.

8. Flow of Search Processing:

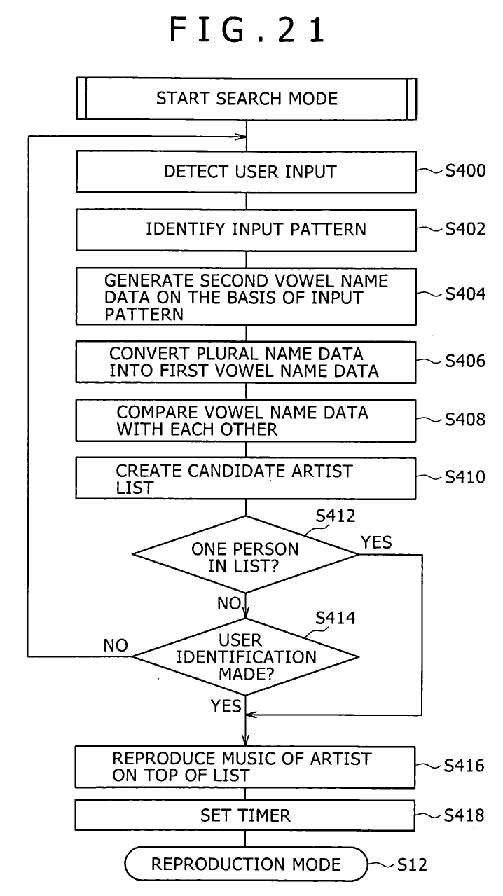

The following describes a detail flow of the search mode (step S40 shown in FIG. 19) in the reproducing apparatus 10 practiced as one embodiment of the invention, with reference to FIG. 21. FIG. 21 is a flowchart indicative of a processing flow (or a processing method) of the search mode in the reproducing apparatus 10.

As shown in FIG. 21, first, in step S400, when a user input operation is executed on the reproducing apparatus 10 after entering the above-mentioned search mode, the detection block 12 detects a user input signal generated by the entered user input operation. For example, when the user taps on the impact acceptance section 62 on the housing 11 of the reproducing apparatus 10 to apply an external impact to the reproducing apparatus 10, the vibration caused by the external impact is detected by the acceleration sensor 60 for example as a user input signal. Alternatively, if the user moves his finger, for example, a myoelectric potential change of the wrist is detected by the myoelectric potential sensor 80 as a user input signal. In each of these input operations, the user enters a vowel name (or a number sequence) of name data subject to search, an artist name for example.

For example, if the user wants to search for artist name “Satou Ichirou,” the user may enter a vowel name (a o u i i r o u” equivalent to the full name of the artist name or only a part of the artist name, “a o u” equivalent to the family name for example. In the latter case, the first name may be added later for more correct searching.

Next, in step S402, the analysis block 14 analyzes the user input signal detected in step S400 to identify an input pattern. For example, the analysis block 14 analyzes the user input signal on the basis of the force, time interval, position and count of the external impact or the myoelectric potential change contained in the detected user input signal, thereby identifying an input pattern corresponding to the user input operation. This input pattern can be replaced by two button operations a and b for example as described before.

Next, in step S404, the vowel generation block 404 of the search block 40 generates second vowel name data corresponding to the input pattern identified in step S402. For example, the vowel generation block 404 converts the above-mentioned input pattern replaced by buttons a and b into a number sequence (“153” for example) and then into a vowel sequence, thereby generating second vowel name data (“a o u” for example) corresponding to the artist name (“Satou” for example) subject to search, for example.

In step S406, the vowel conversion block 402 converts plural pieces of name data stored in the name storage block 42 beforehand into first vowel name data. In the present embodiment, the search processing is executed by use of an artist name for example, so that, in this step S404, plural artist names (“Satou Ichirou” for example) stored in the name storage block 42 are vowel-converted into the first vowel name data (“a o u i i o u” for example).

It should be noted that the vowel conversion step, step S406, may be executed after the user input detection step (namely, after entering the search mode), step S400, and before the vowel generation step, step S404. Alternatively, the vowel conversion step may be executed before the input detection step (namely, before entering the search mode), step S400, in advance.

Next, in step S408, the extraction block 406 makes a comparison between the plural pieces of first vowel name data obtained in step S406 and the second vowel name data generated in step S404. As a result of this comparison, the extraction block 406 extracts one or more pieces of first vowel name data matching or similar to the second vowel name data. In the present embodiment, not only the first vowel name data fully matching the second vowel name data (“a o u” for example) but also the first vowel name data (“a o i” for example) similar to the second vowel name data with a predetermined similarity level or higher is extracted. It should be noted that, if there is no first vowel name data matching or similar to the second vowel name data, the extraction block 406 may be adapted to notify the user thereof, prompting the user to make an input again.

Further, in step S410, the list generation block 408 creates a candidate list, a candidate artist list for example, by putting in a list the name data corresponding to one or more first vowel name data extracted in step S408. As described above, the list generation block 408 is capable of creating a candidate artist list by obtaining the name data of conversion source corresponding to the above-mentioned extracted first vowel name data by referencing the name storage block 42, for example.

In this candidate artist list, the artist names are arranged in the descending order of similarity (or the degree of matching) of vowel name data in accordance with the comparison result obtained in step S408. For example, an artist name corresponding to the first vowel name data fully matching the entered second vowel name data is arranged in the upper level of the candidate artist list, while an artist name corresponding to the first vowel name data partially matching (namely, similar to) the entered second vowel name data is arranged below the fully matching artist name in accordance with the similarity thereof. The candidate artist list thus created is sent by the notification block 48 to the user (audibly or visually).

In step S412, the reproduction control block 20 for example determines whether the candidate artist list created as described above contains only one artist name that corresponds to the first vowel name data fully matching the entered second vowel name data.

If the candidate artist name list is found containing only one artist name, it indicates that the user-desired artist subject to search has been identified. In this case, if a vowel name “a o u” of this artist was entered by the user to search for artist name “Satou Ichirou” for example, only “Satou Ichirou” that fully matches the vowel name “a o u” has been detected, for example.

If this happens, the procedure goes to step S416, in which the reproduction control block 20 automatically starts reproduction of the first music content (or the first music title) of the first album of that artist without user confirmation, thereby setting the timer 409 (step S418). The setting of the timer 409 starts counting the elapsed time since the start of reproduction of the music content in accordance with the created candidate artist list, the elapsed time being used as the reference by which the above-mentioned default list associated with reproduction switching is set. Then, the reproduction control block 20 returns to the above-mentioned reproduction mode (step S12) to end the search mode (step S40).

On the other hand, if the candidate artist list is found containing two or more fully matching artist names as a result of the decision made in step S412, then the procedure goes to step S414. In this case, for example, not only the artist name fully matching the above-mentioned vowel name “a o u” is retrieved, in the above-mentioned example, but also other names “Katou Tarou” and “Satou Yuji” for example are retrieved.

Therefore, in such a situation, the user is prompted to enter a user confirmation if the user wants to select the artist arranged on top of the candidate artist list (step S414). This confirmation may be made by audibly or visibly notifying the user of the contents of the created candidate artist list, as described above, upon which the user recognizes the artist arranged on top of the candidate list for confirmation.

If no input operation indicative of the confirmation by the user is found as a result of the decision made in step S414, it may indicate that the user is not satisfied with the artist arranged on top of the list, upon which the procedure returns to step S400 to detect the additional entry of an artist full name by the user or the entry of another artist name, for example, repeating the above-mentioned detection processing (S400 through S414) until a user confirmation is obtained.

On the other hand, if an input operation by the user is detected as a result of the user's strongly tapping the housing 11 of the reproducing apparatus 10 or widely moving his finger of the wrist on which the myoelectric potential sensor 80 is attached, as a result of the decision made in step S414, then the procedure goes to step S416. Consequently, as with described above, the reproduction control block 20 starts reproduction of the first music content (or the first title) in the first album of the artist arranged on top of the candidate list (step S416), sets the timer 409 (step S418), and returns to the above-mentioned reproduction mode (step S12).

It should be noted that the processing of determining whether a user confirmation has been made or not in step S414 is not restricted to the above-mentioned technique of detecting a special user input operation described above; it is also practicable to determine that a user confirmation has been made by making the timer 409 check whether a user additional input operation has been made within a predetermined time, for example. Namely, if no user input operation has been detected after passing of a predetermined time (three seconds for example) after the user was notified (by visual means for example) of a candidate artist list, for example, it may be regarded that the user is in an implicit consent with the artist and therefore a user confirmation has been obtained, upon which the procedure goes to step S416. On the other hand, if some user input operation has been detected, it may be determined that no user confirmation has been made because of user's additional entry, upon which the procedure returns to step S400. Alternatively, if the fully matching artists contained in the candidate artist list are narrowed down to a predetermined number (three for example), it may be determined that a user confirmation has been made.

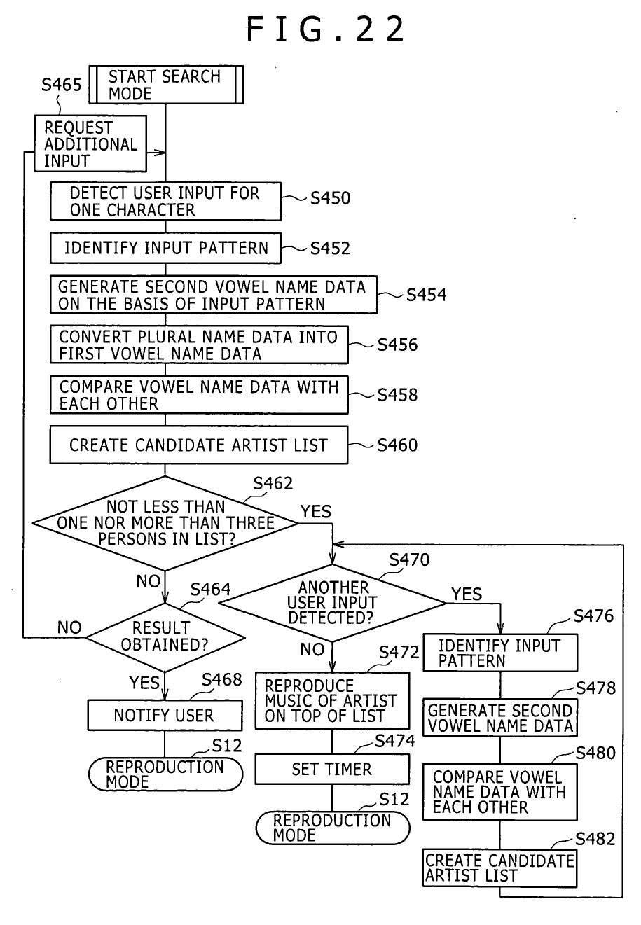

The following describes another example of the detail flow of the search mode (step S40 shown in FIG. 19) in the reproducing apparatus 10 with reference to FIG. 22. FIG. 22 is a flowchart indicative of another example of a processing flow of the search mode (or a search method) in the reproducing apparatus 10.

The following outlines the search processing flow shown in FIG. 22. In this search processing flow, every time the user makes an input operation in which the user enters a vowel name corresponding to a name (an artist name for example) subject to search, letter by letter from the beginning of the name (namely, every time the user enters each of the number sequence corresponding to the vowel sequence of that vowel name), a candidate artist list is updated to gradually narrow down the artists contained in the candidate artist list obtained as a result of the search processing to less than a predetermined number (three or less for example), thereby starting the reproduction of the music of the artist arranged on top of the candidate artist list. The following describes each of the steps of this search processing.

As shown in FIG. 22, after the above-search mode is entered, a user input is detected (S450). Next, an input pattern is identified (S452). On the basis of the identified input pattern, second vowel name data is generated (S454). Plural pieces of name data are converted into first vowel name data (S456). Then, a comparison is made between the first and second vowel name data (S458), thereby creating a candidate artist list (S460). The steps S450 through S460 may generally be realized by the same processing as steps S400 through S410 described above with reference to FIG. 21 except a candidate artist list is created again every time each vowel name is entered letter by letter, so that detail description will be skipped.

Next, in step S462, the reproduction control block 20 determines whether the candidate artist list created in step S460 contains one or more and less than a predetermined number (three or less for example) of artist names corresponding to the first vowel name data fully matching the second vowel name data having the number of letters entered up to the decision of this step.

If, as a result of a decision obtained in step S462, the candidate artist list is found containing no artist (namely, if the decision is No) (step S464), then the procedure goes to step S468 to notify the user thereof, upon which the procedure returns to the reproduction mode (step S12).

If the candidate artist list is found containing four or more artists as a result of the decision made in step S462, then it indicates that the candidate artists have not been sufficiently narrowed down, so that the user is prompted (audibly for example) through step S464 to additionally enter a sequence of letters (step S465), upon which the procedure returns to step S450, in which the user additionally enters a next letter of the artist in the candidate artist list. Consequently, through steps S450 through S460, the search processing is executed with more detail second vowel name data, thereby further narrowing down the number of artists in the candidate artist list.

When, after repeating the above-mentioned procession operations, a decision is made in step S462 that one or more and three or less artists are contained in the candidate artist list, then it indicates that the number of artists has been sufficiently narrowed down, so that the procedure goes to step S470 to reproduce the music of the artist arranged on top of the candidate artist list.

Next, in step S470, the reproduction control block 20 determines another user input operation on the reproducing apparatus 10 has been detected within a predetermined period of time (three seconds for example) after the shift to step S470.

Consequently, if another user input for narrowing down the search result has been detected, then the procedure goes to step S476, in which the search processing is executed by use of the second vowel name data made up of a vowel sequence having more letters in the same manner as described above, thereby creating a more correct candidate artist list again (steps S476 through S482), upon which the procedure returns to step S470.

If no more user input operation has been detected within the above-mentioned predetermined standby time in step S470, then the reproduction control block 20 automatically starts the reproduction of the first music content (or the first title) in the first album of the artist arranged on top of the candidate artist list (step S472) and sets the timer 409 (step S474), returning to the above-mentioned reproduction mode (step S12).

It should be noted that in the above-mentioned search processing flow shown in FIG. 22, steps S470 and S476 through S482 may be skipped, thereby reproducing the music of the artist arranged on top of the candidate artist list as soon as the number of candidate artists becomes three or less without accepting a later user input operation.

The search block 40 used in the search processing flows shown in FIGS. 21 and 22 is used in determining a default list providing the reference for each track jump as “candidate list” or “artist list of user preference” for example as described above. Namely, the candidate list is stored in a storage medium in the reproducing apparatus 10 for at least the above-mentioned predetermined search extension time and, if “reproduction switching command on an artist basis” is generated in this period of time, the reproduction control block 20 reproduction-switches to the music of a next artist in the candidate list. It should be noted that this candidate list may be automatically deleted an appropriate period of time (the above-mentioned predetermined search extension time) after the end of the search mode.

Thus, two examples of the processing flows of the search mode have been described with reference to FIGS. 21 and 22. In the above-mentioned search mode, a search result is outputted in the form of the above-mentioned candidate list, so that, even if the user makes input errors more or less, the search processing can be suitably executed for desired names.

Even if the artist arranged on top of each candidate list is not a user-desired artist, the candidate list remains within the above-mentioned predetermined search extension time. Hence, after returning to the reproduction mode, when the user executes an input operation corresponding to “reproduction switching command on an artist basis,” a track jump can be executed to the first music of an artist next high in similarity, thereby reproducing that music. Therefore, even if the music being reproduced in the reproduction mode is not of a user-desired artist, a track jump can be executed to the music of a user-desired artist in accordance with that candidate artist list, thereby reproducing that music.

9. Flow of Special Processing:

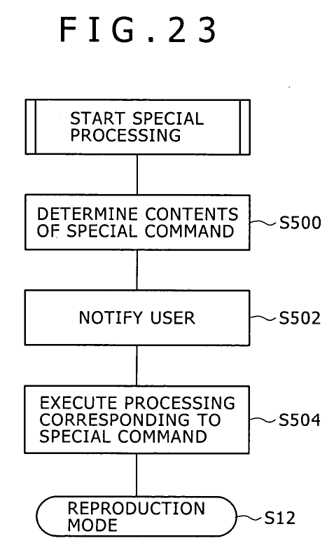

The following describes a detail flow of special processing (step S50 shown in FIG. 19) in the reproducing apparatus 10 practiced as one embodiment of the invention with reference to FIG. 23. FIG. 23 is a flowchart indicative of a special processing flow in the reproducing apparatus 10.

As shown in FIG. 23, first, in step S500, a control block such as the reproduction control block 20 for example determines the type of a special command generated in step S18 shown in FIG. 18. To be more specific, the control block determines whether an entered special command is any one of special commands (for example, a power-on command, a power-off command, a repeat reproduction command on a title or album basis, an audio volume up command, and an audio volume down command). It should be noted that special commands for specifying various functional processing operations of the reproducing apparatus 10 may be set in addition to the commands shown in FIG. 13.

Next, in step S502, the notification block 48 notifies the user of the execution of the processing corresponding to the special command determined by the above-mentioned control block. It is also practicable to execute the processing of step S504 shown below by making the user confirm the execution of this processing and under the condition that an input operation indicative of the user confirmation is accepted. It should be noted that this notification processing need not always be executed.

Further, in step S504, the controller such as the reproduction control block 20 for example executes the processing corresponding to the special command determined above.

The above-described special processing flow allows the user to instruct the reproducing apparatus 10 to execute various kinds of special processing by simple input operations. This saves the user of cumbersome operations of taking out the reproducing apparatus 10 or its remote controller, checking the positions of the power button 71, the mode button 76, the volume control button 77, and the control button 79 for example, and then pressing these buttons, thereby significantly reducing the time and labor in user input processing.

Thus, the reproducing apparatus 10 practiced as one embodiment of the invention and the flows of the processing operations executed thereby have been described in detail. The reproducing apparatus 10 allows the switching of pieces of contents to a user-desired piece of content to be reproduced on the reproducing apparatus 10 only by executing a simple operation of tapping the housing 11 of the reproducing apparatus 10 with a finger of the user or moving a finger of the arm on which the myoelectric potential sensor 80 is attached. This novel configuration makes it unnecessary for the user to take out reproducing apparatus 10 main or a remote controller thereof from a bag or a cloth pocket of the user and make sure of the positions of the controls for the operation of the reproducing apparatus 10 or the remote controller or the browsing of the display unit 107. Consequently, even in a limited space such as inside a crowded train for example, the user is able to easily and quickly execute content reproduction switching operations that are often executed during the reproduction of content, without operating the controls. The novel configuration also allows the user to execute the operations for giving instructions for other than reproduction switching, through a simple control operation.

Further, the input operations associated with the present embodiment are tapping the housing 11 of the reproducing apparatus 10 with the finger and moving the finger of the arm on which the myoelectric potential sensor 80 is attached, so that the user movement is much smaller and easier than “shaking” the reproducing apparatus 10 by the user for operation. Consequently, the user is able to smoothly execute input operations on the reproducing apparatus 10 even in a tight space such as inside a crowed train for example and in an unnoticeable manner.

Still further, the input operations on the reproducing apparatus 10 practiced as one embodiment of the invention (namely, tapping the housing 11 of the reproducing apparatus 10 with a finger) are executable without user's touching directly the housing 11 of the reproducing apparatus 10. Therefore, if the reproducing apparatus 10 is accommodated in a user's cloth pocket (a chest pocket for example), bag, or carrying case for the reproducing apparatus 10 for example, the user is able to indirectly apply an external impact to the reproducing apparatus 10 for input operations via the material making up these carrying facilities. Consequently, in a limited space such as inside a crowed train for example, the user is able to easily execute the input operation without taking out the reproducing apparatus 10 from user's cloth pocket, bag, or carrying case, for example.

Yet further, the reproducing apparatus 10 searches for the names associated with content stored in the reproducing apparatus 10 by use of vowel name data in the search mode, so that search processing can be executed efficiently and the search key words to be entered can be made simple. This novel configuration allows the user to specify the contents of search processing by executing the above-mentioned simple input operations such as tapping the housing 11 of the reproducing apparatus 10 with a finger or moving a finger of the arm on which the myoelectric potential sensor 80 is attached, thereby obtaining desired search results. Consequently, the user need not trouble himself taking out the reproducing apparatus 10 and browsing the display unit 107 for making a confirmation of search results.

In addition, reproduction switching on an artist or album basis on the basis of a candidate list obtained as a result of search processing allows the user to sequentially switching the content subject to reproduction in accordance with the candidate list, thereby finding desired the music content of a desired artist or album, without browsing search results on the display unit 107 of the reproducing apparatus 10 for example. Besides, including not only matching names but also similar names into the candidate list can compensate user input errors.

As described, the use of the reproducing apparatus 10 practiced as one embodiment of the invention allows the user to make a confirmation of content search instructions and search results by executing simple operations through a small movement of a finger. Hence, the user is able to easily search for artist names and album names for example of the content of user preference without operating general controls and browsing the display unit 107. This novel configuration allows the user to easily and quickly search for the content of user preference for reproduction even if the reproducing apparatus 10 stores huge amounts of content (several thousands titles of music, for example). The ease of the search operation in the reproducing apparatus 10 is especially advantageous for the user to make a search operation in a physically tight environment such as inside a crowded train for example in which it is difficult to take out the reproducing apparatus 10 and browse the display unit 107.

While preferred embodiments of the present invention have been described using specific terms, such description is for illustrative purpose only, and it is to be understood that changes and variations may be made without departing from the spirit or scope of the following claims.

For example, the content data according to the invention is not restricted to the above-mentioned music content examples; namely, the content data covers audio content such as radio programs and lectures for example, video content such as still and moving images like movies, television programs, video programs, photographs, drawings, and graphics for example, electronic books (E-books), games, software, and any other types of content data.

In the above-mentioned embodiments, an example is used in which a search apparatus is applied, but not exclusively, to a reproduction apparatus, especially to a portable audio player. For example, the search apparatus according to the invention is applicable to various types of portable devices including a portable video player, a mobile phone, a PDA (Personal Digital Assistant), and a portable game machine. Further, the search apparatus according to the invention is applicable to various types of stationary reproducing devices like a HDD player, a DVD player, and a memory player, computer apparatuses (of note type and desktop type) like a personal computer (PC), household game machines, home information appliances, car audio equipment, car navigators, Kiosk terminals, and other electronic devices, for example.

Especially, the search apparatus according to the invention is suitably applicable to mobile phones, PHS terminals, and portable terminals, for example, on which the user must often search for the name data of the destinations of communication.

What is claimed is:

1. A reproduction apparatus comprising:
a reproduction block for reproducing plural pieces of content stored in a storage medium;
a detection block for detecting, as a user input signal, an external impact applied by a user to said reproduction apparatus during reproduction of content data by said reproduction block;
an analysis block for analyzing said user input signal to identify an input pattern;
a pattern storage block for storing a preset operation pattern;
a command generation block for comparing said input pattern identified by said analysis block with said operation pattern stored in said pattern storage block to generate a command corresponding to an operation pattern that matches said input pattern; and
a reproduction control block for switching content data to be reproduced by said reproduction block in accordance with said command.

2. The reproduction apparatus according to claim 1, wherein
said plural pieces of content data stored in said storage medium are music content data and
said reproduction control block switches content data to be reproduced by said reproduction block on one of a music content data title basis, a music content data album basis, and a music content data artist basis in accordance with a type of said command.

3. The reproduction apparatus according to claim 1, wherein
said plural pieces of content data stored in said storage medium are classified into plural major categories and plural minor categories and
said reproduction control block, when said command is entered during reproduction of content data in one minor category in one major category, switches to one of another piece of content data in a same minor category, a piece of content data in another minor category in a same major category, and a piece of content data in another major category in accordance with a type of said command.

4. The reproduction apparatus according to claim 3, wherein
said plural pieces of content data stored in said storage medium are music content data and
each of said plural major categories corresponds to an artist of said music content data and each of said plural minor categories corresponds to an album of said music content data.

5. The reproduction apparatus according to claim 1, further comprising:
a control block for controlling at least one of capabilities of said reproducing apparatus such as power on/off, audio output volume up/down, content data search mode execution, content data repeat reproduction, content data reproduction start/stop, content data reproduction pause, and content data fast/rewind reproduction in accordance with a type of said command.

6. The reproduction apparatus according to claim 1, wherein said external impact to said reproduction apparatus is given by a vibration that is caused by tapping by a user onto a housing of said reproduction apparatus.

7. The reproduction apparatus according to claim 1, wherein said detection block is an acceleration sensor for detecting a vibration caused by an external impact to said reproduction apparatus.

8. The reproduction apparatus according to claim 1, wherein said detection block is arranged around an inner surface of a housing of said reproduction apparatus.

9. The reproduction apparatus according to claim 1, wherein said detection block is a microphone for picking up an impact sound caused by said external impact to said reproducing apparatus.

10. The reproduction apparatus according to claim 1, wherein said detection block is arranged in the plural in said reproduction apparatus, thereby detecting both a position and a force of said external impact to said reproduction apparatus.

11. The reproduction apparatus according to claim 1, wherein
a housing of said reproduction apparatus has at least one impact acceptance block for accepting said external impact applied by said user and
said detection block is arranged in accordance with a position of said impact acceptance block.

12. The reproduction apparatus according to claim 1, wherein
a housing of said reproduction apparatus has at least two impact acceptance blocks for accepting said external impact applied by said user and
said analysis block analyzes said user input signal on the basis of a force of said external impact.

13. The reproduction apparatus according to claim 10, wherein
said detection block is an acceleration sensor for detecting a vibration caused by said external impact to said reproduction apparatus and
said acceleration sensor is arranged so as to detect a vibration in a direction in accordance with a direction of said external impact applied by said user to said impact acceptance block.

14. The reproduction apparatus according to claim 10, wherein
said detection block and said impact acceptance block are each arranged in the plural and
in order to prevent a line connecting said plurality of detection blocks from orthogonally crossing a line connecting said plurality of impact acceptance blocks on a plane approximately vertical to a direction of said external impact to said reproduction apparatus, a relative position of said plurality of detection blocks and said plurality of impact acceptance blocks is adjusted.

15. The reproduction apparatus according to claim 1, wherein said analysis block analyzes said user input signal on the basis of a force of said external impact to said reproduction apparatus.

16. The reproduction apparatus according to claim 1, wherein said analysis block analyzes said user input signal on the basis of a time interval of said external impact to said reproduction apparatus.

17. The reproduction apparatus according to claim 1, wherein said analysis block analyzes said user input signal on the basis of a position of said external impact to said reproduction apparatus.

18. The reproduction apparatus according to claim 1, wherein said analysis block analyzes said user input signal on the basis of a count of said external impact to said reproduction apparatus.

19. The reproduction apparatus according to claim 1, wherein, when said reproduction apparatus is powered on, said reproduction block automatically sequentially continuously reproduces said plural pieces of content data stored in said storage medium.

20. The reproduction apparatus according to claim 1, wherein said reproduction apparatus is a portable device.

21. The reproduction apparatus according to claim 1, further comprising:
a notification block for notifying said user of at least one of said input pattern identified by said analysis block and contents of said command generated by said command generation block.

22. The reproduction apparatus according to claim 1, wherein said content data includes at least one of audio data and video data.

23. The reproduction apparatus according to claim 1, wherein said reproduction control block notifies said user of necessary information in at least one of manners, audible and visual.

24. A computer program for making a computer execute the steps of:
detecting, as a user input signal, an external impact applied by a user to said reproduction apparatus during reproduction of content data stored in a recording medium;
analyzing said user input signal to identify an input pattern;
comparing said identified input pattern with said operation pattern stored in said pattern storage block to generate a command corresponding to an operation pattern that matches said input pattern; and
switching content data during reproduction in accordance with said command.

25. A reproduction control method comprising the steps of:
detecting, as a user input signal, an external compact applied by a user to said reproduction apparatus during reproduction of content data stored in a recording medium;
analyzing said user input signal to identify an input pattern;
comparing said identified input pattern with said operation pattern stored in said pattern storage block to generate a command corresponding to an operation pattern that matches said input pattern; and
switching content data during reproduction in accordance with said command.
